(19) United States
(12) Patent Application Publication
(10) Pub. No.: US 2025/0103183 A1
(43) Pub. Date: Mar. 27, 2025

(54) DISPLAY APPARATUS AND CONTROL METHOD

(71) Applicant: VIDAA (NETHERLANDS) INTERNATIONAL HOLDINGS B.V., Duiven (NL)

(72) Inventors: Qingwei MENG, Duiven (NL); Jingqi FU, Duiven (NL); Congpeng ZHANG, Duiven (NL); Jianmin KANG, Duiven (NL)

(21) Appl. No.: 18/974,343

(22) Filed: Dec. 9, 2024

Related U.S. Application Data
(63) Continuation of application No. PCT/EP2023/086419, filed on Dec. 18, 2023.

(30) Foreign Application Priority Data
Apr. 23, 2023 (CN) 202310445917.1
May 8, 2023 (CN) 202310511871.9
Jul. 14, 2023 (CN) 202310867954.1
Aug. 1, 2023 (CN) 202310963549.X

(51) Int. Cl. G06F 3/0482; G06F 3/04817; G06F 16/9538

(52) U.S. Cl. CPC G06F 3/0482; G06F 3/04817; G06F 16/9538

(57) ABSTRACT

The present disclosure discloses a display apparatus and a control method. The control method includes: presenting the page from the browser application on the user interface, in response to a favorite operation for the target webpage in the browser application, present the target webpage based on the webpage loading mode in the display apparatus, or sending a QR code included in a shared page to one or more users associated with the target sharing path after a page sharing function is started.

### CROSS REFERENCE TO RELATED APPLICATION

This application is continuation of PCT Application No. PCT/EP2023/086419, filed on Dec. 18, 2023, which claims priorities to Chinese patent application No. 202310445917.1 filed on Apr. 23, 2023, No. 202310511871.9 filed on May 8, 2023, No. 202310867954.1 filed on Jul. 14, 2023, and No. 202310963549.X filed on Aug. 1, 2023. The entire contents of all of the above are incorporated herein by reference.

### TECHNICAL FIELD

The present disclosure relates to the field of display apparatuses and, in particular, to a display apparatus and a control method for a browser.

### BACKGROUND

With the continuous improvement of the intelligence of display apparatuses, display apparatuses can provide users with more services. For example, in addition to providing a viewing path for television (TV) programs, a TV can also provide an application entry for browser search, which is a path for users watching the content from various websites.

When the display apparatus plays media resources such as video and audio, it can use the browser to present. After the user selects a media resource to be played, the browser will load the media resource, and the user cannot see the content of the media resource, i.e., the image of the media resource play, until the media resource is loaded. Therefore, in the process of loading media resources through the browser, users cannot know the progress of media resource loading, which affects the user experience.

In order to facilitate users to access websites through browsers, the display apparatus can provide some website icons as shortcut entrances for users to access websites. For example, a preset website, i.e., an icon of a website configured by default when the TV leaves the factory can be provided in the recommendation bar of the TV. A user can quickly open the webpage corresponding to the website through the icon, and does not need to enter the website URL in the search box. However, for some non-preset websites, e.g., the user's favorite websites, the display apparatus needs to obtain the domain name address of the website first, and then accesses the website through the domain name address, which causes the loading speed of the website to slow down and affects the smoothness of the user's operation. On the browser page, how to quickly and easily share it with other users is also a big challenge.

### SUMMARY

Some embodiments of the present disclosure provide a display apparatus, including: a display, configured to present an image and/or a user interface; and at least one processor, configured to execute computer instructions to cause the display apparatus to: display a page from a browser application in the display apparatus on the display, and in response to a favorite operation for a target webpage in the browser application, determine a webpage loading mode in the display apparatus; obtain icon information of the target webpage based on the webpage loading mode in the display apparatus; and based on a selection operation for the icon information of the target webpage, present the target webpage on the display; wherein the webpage loading mode in the display apparatus comprises a first loading mode and a second loading mode, and a webpage loading speed when the display apparatus is in the first loading mode is less than a webpage loading speed when the display apparatus is in the second loading mode.

Some embodiments of the present disclosure provide a control method for a display apparatus, including: displaying a page from a browser application in the display apparatus on a user interface presented on a display of a display apparatus, in response to a favorite operation for the target webpage in the browser application, determining a webpage loading mode in the display apparatus; obtaining icon information of the target webpage based on the webpage loading mode in the display apparatus; based on a selection operation for the icon information of the target webpage, presenting the target webpage on the display; wherein the webpage loading mode in the display apparatus comprises a first loading mode and a second loading mode, and a webpage loading speed when the display apparatus is in the first loading mode is less than a webpage loading speed when the display apparatus is in the second loading mode.

### BRIEF DESCRIPTION OF FIGURES

FIG. 1 is a schematic diagram of an operation scenario between a display apparatus and a control device according to some embodiments of the present disclosure.

FIG. 2 is a hardware configuration block diagram of a control device according to some embodiments of the present disclosure.

FIG. 3 is a hardware configuration block diagram of a display apparatus according to some embodiments of the present disclosure.

FIG. 4 is a schematic diagram of a software configuration in a display apparatus according to some embodiments of the present disclosure.

FIG. 5 is a schematic diagram of a flow of a method of a display apparatus loading a webpage through a browser according to some embodiments of the present disclosure.

FIG. 6 is a schematic diagram of a scenario of switching a loading mode of a browser according to some embodiments of the present disclosure.

FIG. 7 is a schematic diagram of a flow of a display apparatus performing a webpage loading process according to some embodiments of the present disclosure.

FIG. 8 is a schematic diagram of a flow of presenting webpage loading progress in an normal loading mode in a display apparatus based on a loading state according to some embodiments of the present disclosure.

FIG. 9 is a schematic diagram of an effect of a browser homepage interface in a first window according to some embodiments of the present disclosure.

FIG. 10 is a schematic diagram of an effect of a web interface in a second window according to some embodiments of the present disclosure.

FIG. 11 is a schematic diagram of a flow of presenting a webpage loading progress at a top of a webpage interface of webpage access address in the display apparatus according to some embodiments of the present disclosure.

FIG. 12 is a schematic diagram of an effect of presenting a webpage loading progress in an extremely-fast loading mode in a display apparatus according to some embodiments of the present disclosure.

FIG. 13 is a schematic diagram of a scenario in which a display apparatus generates a long pressing button prompt message according to some embodiments of the present disclosure.

FIG. 14 is a schematic diagram of a scenario where a display apparatus generates a page-turning prompt message according to some embodiments of the present disclosure.

FIG. 15 is a schematic diagram of a flow of a method of loading a webpage through a browser according to some embodiments of the present disclosure.

FIG. 16 is an architecture diagram of a display control system according to some embodiments of the present disclosure.

FIG. 17 is a flow chart of a display control method according to some embodiments of the present disclosure.

FIG. 18 is a schematic diagram of presenting icon information according to some embodiments of the present disclosure.

FIG. 19 is a flow chart of another display control method according to some embodiments of the present disclosure.

FIG. 20 is a sub-flow chart of a display control method according to some embodiments of the present disclosure.

FIG. 21 is a schematic diagram of homepage screenshot information according to some embodiments of the present disclosure.

FIG. 22 is another sub-flow chart of a display control method according to some embodiments of the present disclosure.

FIG. 23 is a flow chart of another display control method according to some embodiments of the present disclosure.

FIG. 24 is a flow chart of another display control method according to some embodiments of the present disclosure.

FIG. 25 is a flow chart of another display control method according to some embodiments of the present disclosure.

FIG. 26 is a flow chart of another display control method according to some embodiments of the present disclosure.

FIG. 27 is a flow chart of another display control method according to some embodiments of the present disclosure.

FIG. 28 is a schematic diagram of configuration data processing according to some embodiments of the present disclosure.

FIG. 29 is a schematic diagram of a structure of a display control device according to some embodiments of the present disclosure.

FIG. 30 is a schematic diagram of a software architecture of a display apparatus according to some embodiments of the present disclosure.

FIG. 31 is a schematic diagram of an interaction between a browser, a player application and an application performance management (APM) according to some embodiments of the present disclosure.

FIG. 32 is a schematic diagram of a flow of a browser-based video play method according to some embodiments of the present disclosure.

FIG. 33 is a schematic diagram of an interface of a browser homepage according to some embodiments of the present disclosure.

FIG. 34 is a schematic diagram of video play according to some embodiments of the present disclosure.

FIG. 35 is a schematic diagram of a layer distribution of a display apparatus according to some embodiments of the present disclosure.

FIG. 36 is a schematic diagram of a flow of a play error handling method according to some embodiments of the present disclosure.

FIG. 37 is a schematic diagram of an interface of a browser homepage according to some embodiments of the present disclosure.

FIG. 38 is a schematic diagram of an interface of a browser homepage according to some embodiments of the present disclosure.

FIG. 39 is a schematic diagram of an interface of a browser homepage according to some embodiments of the present disclosure.

FIG. 40 is a schematic diagram of an interface of a browser homepage according to some embodiments of the present disclosure.

FIG. 41 is a flow chart of enabling a page sharing function of a browser application in the display apparatus according to some embodiments of the present disclosure.

FIG. 42 is a schematic diagram of a setting menu of a browser application according to some embodiments of the present disclosure.

FIG. 43 is a flow chart of sharing a page content of a browser page in a display apparatus according to some embodiments of the present disclosure.

FIG. 44 is a flow chart of adjusting a browser page to a first selection mode in a display apparatus according to some embodiments of the present disclosure.

FIG. 45 is a schematic diagram of a structure of a system architecture of a display apparatus that implements a page sharing function according to some embodiments of the present disclosure.

FIG. 46 is a flow chart of obtaining content to be shared in a display apparatus according to some embodiments of the present disclosure.

FIG. 47 is a flow chart of sharing two-dimensional code in a display apparatus according to some embodiments of the present disclosure.

FIG. 48 is a schematic diagram of a user A sharing a page content with a user B through a browser application of a television in an example 1 according to some embodiments of the present disclosure.

FIG. 49 is a schematic diagram of the user B presenting the page content shared by the user A based on the shared two-dimensional code in the example 1 according to some embodiments of the present disclosure.

FIG. 50 is a flow chart of sharing a page content of a browser page in a display apparatus according to some embodiments of the present disclosure.

FIG. 51 is a flow chart of obtaining a content to be shared in a display apparatus according to some embodiments of the present disclosure.

FIG. 52 is a flow chart of obtaining content to be shared in a display apparatus according to some embodiments of the present disclosure.

FIG. 53 is a schematic diagram of a user A sharing a page content with a user B through a browser application of a television in an example 2 according to some embodiments of the present disclosure.

FIG. 54 is a schematic diagram of a user A sharing a page content with a user B through a browser application of a television in an example 3 according to some embodiments of the present disclosure.

FIG. 55 is a schematic diagram of a pop-up window presented when a selection is invalid according to some embodiments of the present disclosure.

FIG. 56 is a schematic diagram of a pop-up window presented when a selection is valid according to some embodiments of the present disclosure.

### DETAILED DESCRIPTION

In order to make the purpose and embodiments of the present disclosure clearer, the illustrative embodiments of the present disclosure will be clearly and completely described below in combination with the accompanying drawings in the exemplary embodiments of the present disclosure, and it is obvious that the illustrative embodiments described are only part of the embodiments of the present disclosure, not all embodiments.

It should be noted that the brief description of terms in this application is only to facilitate understanding of the embodiments described below, and is not intended to limit the embodiments of this application. Unless otherwise stated, these terms should be understood according to their ordinary and usual meaning.

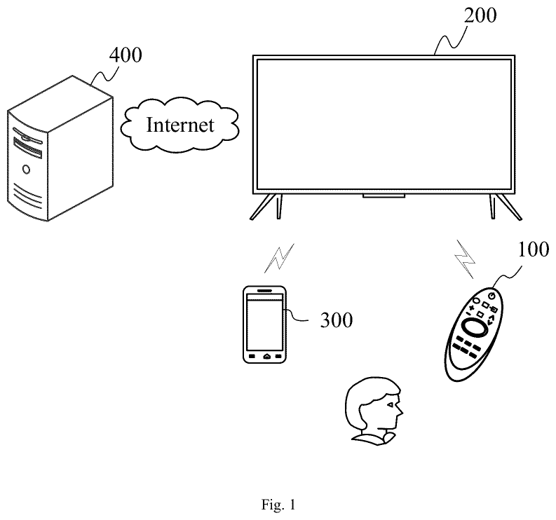

An embodiment of the present disclosure provides a display apparatus and a display control method, and the display control method may be applied to the display apparatus. FIG. 1 is a schematic diagram of an interaction between a display apparatus and a control device according to some embodiments of the present disclosure. As shown in FIG. 1, the user can operate the display apparatus 200 through a mobile terminal 300 or the control device 100. The control device 100 can be a remote control, and the remote control can communicate with the display apparatus 200 through infrared protocol, Bluetooth protocol, or the remote control can also control the display apparatus 200 by wireless or other wired means.

The user can control the display apparatus 200 by entering user commands through the buttons, voice input, control panel, etc., on the remote control. For example, the user can control the display apparatus 200 to switch the presented page through the up and down keys on the remote control, and control the video played by the display apparatus 200 to play or pause through the play/pause button.

In some embodiments, the user may also use a mobile terminal, a tablet computer, a computer, a laptop computer, and other intelligent devices to control the display apparatus 200. For example, the user can control the display apparatus 200 through an application installed on the smart device. The application can be configured to provide the user with various controls in an intuitive user interface on the screen associated with the smart device.

In some embodiments, the mobile terminal 300 can be connected and communicated with the software application installed with the display apparatus 200 through a network communication protocol to realize the purpose of one-to-one control operation and data communication. For example, a command protocol can be established with a mobile terminal 300 and a display apparatus 200, the remote control keyboard is synchronized to the mobile terminal 300, the function of controlling the display apparatus 200 is realized by controlling the user interface on the mobile terminal 300, or the content presented on the mobile terminal 300 can be transmitted to the display apparatus 200, and the function of synchronous display is realized.

As shown in FIG. 1, the display apparatus 200 and the server 400 can communicate data through a variety of communication modes, and the display apparatus 200 can be allowed to communicate through a local area network (LAN), a wireless local area network (WLAN) and other networks. The server 400 can deliver a variety of content and interactions to the display apparatus 200. For example, the display apparatus 200 interacts by sending and receiving messages, as well as an electronic program guide (EPG), receives software program updates, or accesses a remotely stored digital media library.

The display apparatus 200 can be a liquid crystal display, an organic light-emitting diode (OLED) display, a projection display equipment, an intelligent terminal, such as a mobile phone, a tablet computer, a smart TV, a laser projection device, an electronic table, etc.

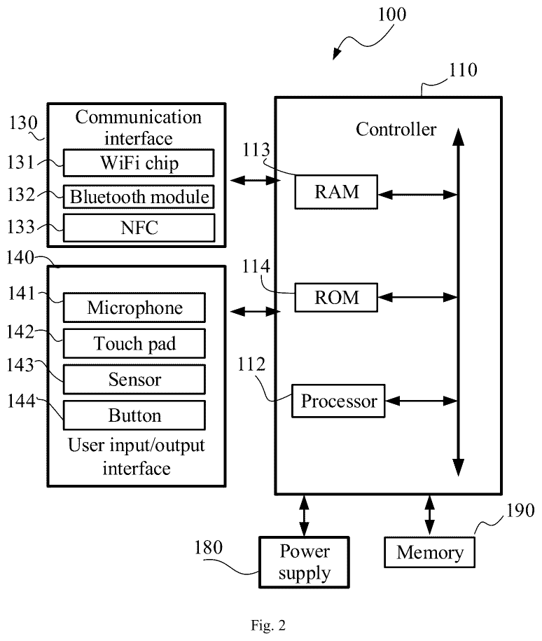

FIG. 2 is a configuration block diagram of the control device 100 in the exemplary embodiment of the present disclosure, as shown in FIG. 2, the control device 100 includes a controller 110, a communication interface 130, a user input/output interface 140, a memory 190, a power supply. The control device 100 can receive the operation command input from the user, and convert the operation command into the instruction that the display apparatus 200 can recognize and respond, and play an interactive intermediary role between the user and the display apparatus 200.

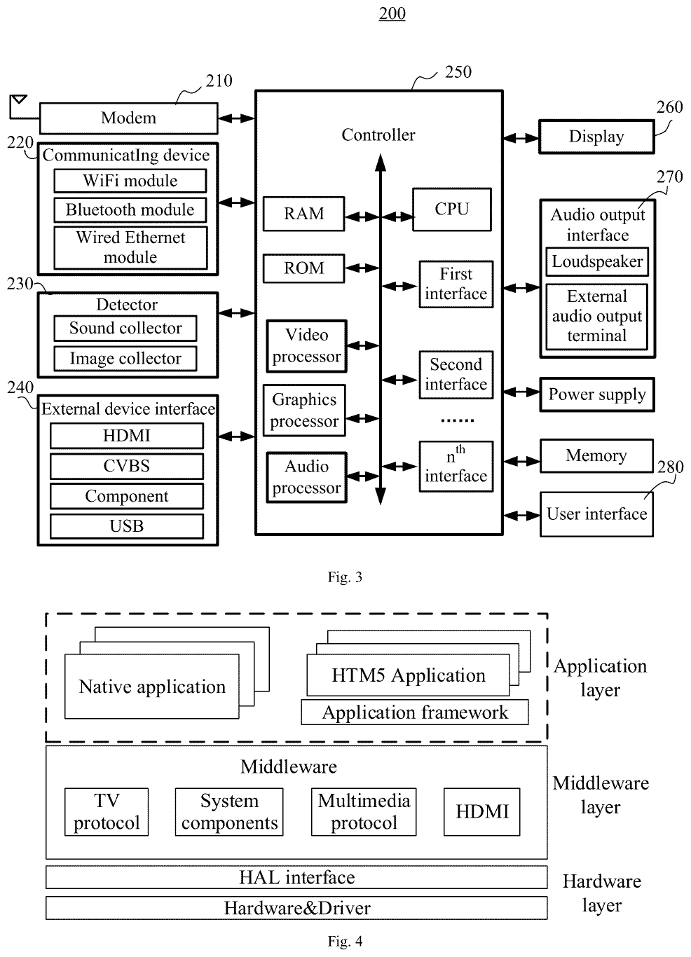

For example, taking the display apparatus as an example of television, FIG. 3 is a hardware configuration block diagram of a display apparatus 200 according to some embodiments of the present disclosure. As shown in FIG. 3, the display apparatus 200 includes: a modem 210, a communicating device 220, a detector 230, an external device interface 240, a controller 250, a display 260, an audio output interface 270 and at least one of a memory, a power supply or a user interface.

The modem 210 can receive broadcast television signals by wired or wireless reception, as well as demodulate audio and video signals, such as EPG data signals, from multiple wireless or cable broadcast television signals. The detector 230 can be used to acquire signals from the external environment or interact with the outside.

In some embodiments, the frequency point demodulated by the modem 210 is controlled by the display apparatus, and the display apparatus can send a control signal according to the user's selection, so that the modem responds to the frequency of the television signal selected by the user to modulate/demodulate the television signal carried by the frequency.

Radio and television signals can be divided into terrestrial broadcasting signals, cable broadcasting signals, satellite broadcasting signals or Internet broadcasting signals according to different television signal broadcasting systems. Alternatively according to different modulation types, they can be divided into digital modulation signals, analog modulation signals, etc. Alternatively according to the different types of signals, they can be divided into digital signals, analog signals, etc.

In some embodiments, the controller 250 and the modem 210 may be located in different split devices, that is, the modem 210 may also be located in the external device of the main device where the controller 250 is located, such as an external set-top box, etc.

In some embodiments, the communicating device 220 may be a component used to communicate with an external device or an external server according to various communication protocol types. For example, the communicating device can include at least one of Wifi chips, Bluetooth communication protocol chips, wired Ethernet communication protocol chips and other network communication protocol chips or near-field communication protocol chips, or the infrared receivers.

In some embodiments, the detector 230 can be used to collect signals from the external environment or interact with the outside, and may include an optical receiver and a temperature sensor, etc.

Here, the optical receiver can be used for collecting the ambient light intensity, and adaptively adjusts the display parameters according to the ambient light intensity, etc.; the temperature sensor can be used to sense the ambient temperature, so that the display apparatus 200 can adaptively adjust the display color temperature of the image, for example, when the ambient temperature is high, the color temperature of display image of the display apparatus 200 can be adjusted to be cold tone, or when the ambient temperature is low, the color temperature of display image of the display apparatus 200 can be adjusted to be warm tone.

In some embodiments, the detector 230 may also include an image collector, such as a camera, a webcam, etc., which can be used for collecting external environmental scenes, and for collecting the user's attributes or interacting gestures with the user, can adaptively change the display parameters, and can also recognize the user's gestures, so as to realize the function of interaction with the user.

In some embodiments, the detector 230 may also include a sound collector, such as a microphone, which can be used to receive the user's voice. For example, including a voice signal of a command that a user controls a display apparatus 200, or collecting an environmental sound, is used for identifying an environment scene type, so that the display apparatus 200 can adaptively adapt to environmental noise.

In some embodiments, the external device interface 240 may include, but is not limited to any one or more interfaces, such as a high-definition multimedia interface (HDMI), an analog or data high-definition component input interface, a composite video input interface, a universal serial bus (USB) input interface, an RGB port, etc. Alternatively, it can be a composite input/output interface with above multiple interfaces.

As shown in FIG. 3, the controller 250 may include at least one of a central processing unit, a video processor, an audio processor, a graphics processing unit, random access memory (RAM), read-only memory (ROM), or the first to n^{th} interfaces for input/output. The communication bus connects the individual components.

In some embodiments, the controller 250 can control the operation of the display apparatus and respond to the user's operation through various software programs stored on the memory. For example, a user can input a user command in a graphical user interface (GUI) presented on the display 260, and the user input interface receives the user input command through the graphical user interface, or the user can input a user command by inputting a specific sound or gesture, and the user input interface recognizes the sound or gesture through a sensor to receive the user input command.

In some embodiments, RAM may be used to store temporary data for an operating system or other running programs; ROMs can be used to store instructions for various system startups, for example, they can be used to store instructions for a basic input-output system (BIOS) startup. The ROM can be used to complete the power-on self-test of the system, the initialization of each functional module in the system, the basic input/output driver of the system, and the boot for operating system.

In some embodiments, when a boot or start signal is received, the display apparatus 200 power supply starts up, and the central processing unit runs the system boot instructions in the ROM, and copies the temporary data of the operating system stored in the memory to RAM so that the operating system can be easily started or run. When the operating system boots up, the CPU then copies the temporary data of various applications in the memory to RAM, and then makes it easier to start or run various applications.

In some embodiments, the central processing unit may be used to execute operating system and application instructions stored in memory, as well as to execute various applications, data, and content based on various interactive instructions received from external input, so as to ultimately display and play various audio and video contents.

In some exemplary embodiments, the central processing unit may include a plurality of processors. The processors can include a primary processor and one or more sub-processors. The primary processor is used to perform some operations on the display apparatus 200 in pre-powered mode, and/or on the display screen in normal mode. One or more sub-processors are used for an operation in a state such as standby mode.

In some embodiments, the video processor can be configured to receive an external video signal, and according to the standard codec protocol of the input signal, perform video processing such as decompression, decoding, scaling, noise reduction, frame rate conversion, resolution conversion, transparency setting, image synthesis, etc., and can obtain a signal that can be presented or played on the display apparatus 200 directly.

In some embodiments, the video processor may include a demultiplexing module, a video decoding module, an image synthesis module, a frame rate conversion module, a display formatting module, and the like.

Here, the demultiplexing module is used for demultiplexing the input audio and video data stream, such as inputting moving picture experts group-2 (MPEG-2), the demultiplexing module demultiplexes the input into video signals and audio signals, etc. The video decoding module is used to process the demultiplexed video signal, including decoding and scaling processing, transparency settings, etc.

The image synthesis module, such as an image synthesizer, is used to superimpose and blend the GUI signal generated by the graphics generator according to the user input or generated by itself with the scaled video image to generate an image signal that can be presented. The frame rate conversion module is used to convert the input video frame rate, such as converting the 60 Hz frame rate to 120 Hz frame rate or 240 Hz frame rate, and the usual format is implemented by interpolating frames. The display format module is used to receive the video output signal with converted frame rate, and change the video output signal to conform to the signal of the display format, such as the output RGB data signal.

In some embodiments, the audio processor can be used to receive an external audio signal, decompress and decode according to the standard codec protocol of the input signal, and process such as noise reduction, digital-to-analog conversion, and amplification processing to obtain a sound signal that can be played in the speaker.

In some embodiments, the video processor may include one or more chips. Audio processors can also include one or more chips. Meanwhile, the video processor and audio processor can be a single chip, or they can be integrated with the display apparatus in one or more chips.

In some embodiments, the interface for input/output can be used for audio output, that is, receiving the sound signal output from the audio processor under the control of the controller 250, and outputting to the external amplifier such as the speaker, and in addition to the speaker arranged in the display apparatus 200 itself, the external audio output terminal of the sound device of the external device can be output, such as the external audio interface or the headphone interface, etc. The audio output can also include a short-range communication module in the communication interface, for example, a Bluetooth module for the sound output of a speaker via Bluetooth connection.

In some embodiments, the graphics processor can be used to produce various graphics objects, such as icons, operation menus, and present graphics for user input instructions. The graphic processors can include an operational unit, which perform operations by receiving various interactive instructions from the user, presenting various objects according to display properties, and include a renderer, which renders various objects obtained by the operational unit, and the rendered objects are presented on the display.

In some embodiments, the graphics processor and the video processor can be integrated with the settings, or they can be set separately, the processing of the graphics signal output to the display can be performed when the settings are integrated, and different functions can be performed separately when the settings are separated, such as the graphics processing unit (GPU)+frame rate conversion technology (FRC) architecture.

The display 260 can comprise at least one of liquid crystal displays, OLED displays, touch displays or projection displays, and can also be a projection device and a projection screen.

In some embodiments, a display 260 may be used to present a page from an application. For example, an application can be a browser application, and the display 260 can be used to present a corresponding page from the browser application.

In some embodiments, the display 260 may be used to receive audio and video signals output from an audio processor and a video processor, present video content and images, play audio of video content, and present a component of a menu control interface.

In some embodiments, the display 260 may be used to present a user interface for control of the display apparatus 200.

In some embodiments, the display apparatus 200 can establish communication with the external control device 100 and a content providing device through a communicating device 220 to send and receive control signals and data signals.

In some embodiments, the memory may store various software modules or drivers for driving the display apparatus 200, such as a variety of software modules stored in the first memory, including: at least one of basic module, detection module, communication module, display control module, browser module, or various service modules, etc.

Here, the basic module is an underlying software module used for signal communication between each hardware in the display apparatus 200 and sending processing and control signals to the upper module. The detection module is a management module that collects various types of information from various sensors or user input interfaces, converts digital-to-analog data, and analyzes and manages it.

For example, a voice recognition module can include a voice analysis module and a voice command database module. The display control module can be used to control the display to present the image content, and can be used to play multimedia image content and UI and other information. A communication module can be used for control and data communication with external devices. A browser module can be used to perform data communication between browsing servers. Service modules can be used to provide various services and applications. Further, the memory can also be used to receive and store external and user data, images of individual items in various user interfaces, and visual renderings of focus objects.

In some embodiments, the user interface can be used to receive signals from the control device 100, e.g., receive the infrared control signal sent from an infrared remote control or the like.

The power supply can provide power to the display apparatus 200 through the power input of the external power supply under the control of the display apparatus.

In some embodiments, the display apparatus 200 may receive an operation input from the user through the communicating device 220. For example, when the communicating device 220 is a touch component, the touch component can form a touch screen together with the display 260. On the touch screen, the user can input different commands through touch operation, such as clicking, swiping, long pressing, double tapping and other touch commands, and different touch commands can represent different control functions.

In order to realize the different touch operations mentioned above, the touch component can generate different electrical signals when the user inputs different touch operations, and the generated electrical signals are sent to the display apparatus. The display apparatus can perform feature extraction on the received electrical signal, thereby determining the control function to be performed by the user based on the extracted features.

For example, when a user enters a touch operation at any of the application icon positions in the display interface of an application, the touch component senses the touch operation and generates an electrical signal. After the display apparatus receives the electrical signal, it can first determine the duration of the corresponding level of the touch operation in the electrical signal, and when the duration is less than a preset time threshold, it is recognized that the user input is a click touch command. The display apparatus then extracts the position features generated by the electrical signal to determine the touch position. When the touch position is within the display range of an application icon, it is determined that the user has entered a tap command at the application icon position. Correspondingly, the click touch command in the current scenario is used for launching the application corresponding to the running application or switching the display interface, that is, the display apparatus can start running the application or switch an interface in the application.

In some embodiments, the communicating device 220 may also be an external control component, such as a mouse, or a remote control, etc., that establishes communication connection with a display apparatus. When the user performs different control operations on the external control component, the external control component can, in response to the user's control operation, generate different control signals, and send the generated control signals to the display apparatus. The display apparatus can perform feature extraction on the received control signal, thereby determining the control function to be performed by the user according to the extracted features.

For example, when a user clicks the left mouse button anywhere in the application's display interface through an external control component, the external control component can sense the control operation and generate a control signal. After the display apparatus receives the control signal, can recognize that the user is inputting a clicking command via the external control component according to that the dwell time of the action in the position according to the control signal is less than the preset time threshold. The clicking command is used to open a corresponding interface in the application in the current scenario, or to switch display interface within the application, or to move the position of the mouse cursor.

In some embodiments, the communicating device 220 may also be a control component connected with the display 260, and in the case of a desktop computer, the control component may be a keyboard connected to the display. The user can enter different commands through the keyboard, such as clicking, switching, and other operation commands.

For example, the user can enter click commands, switch commands, etc., through a corresponding shortcut key. For example, the user can issue a sliding operation by selecting the “Tab” key and an arrow key, that is, when the user selects the “Tab” key and the arrow key on the keyboard at the same time, the display apparatus can receive the key signal, determine that the user has issued an operation of switching operations in the direction corresponding to the arrow key, and then the display apparatus can control the page turning or scrolling of the presented page in the browser application.

FIG. 4 is a schematic diagram of a software configuration in the display apparatus according to some embodiments of the present disclosure. In some embodiments, the system is divided into four layers, from top to bottom, the application (Applications) layer (hereinafter referred to as the “application layer”), the application framework layer (hereinafter referred to as the “framework layer”), the Android runtime (Android runtime) and the system library layer (hereinafter referred to as the “system runtime layer”), and the kernel layer.

In some embodiments, at least one application runs in the application layer, which may be a window application, a system setting application, a clock application, a camera application, etc., built-in the operating system. It can also be an application developed by a third-party developer.

The framework layer provides an application programming interface (API) and programming framework for applications at the application layer. The application framework layer includes a number of predefined functions. The application framework layer acts as a processing center that determines the actions of the applications in the application layer.

As shown in FIG. 4, the application framework layer in the embodiments of the present disclosure includes a manager, a content provider and a view system.

In some embodiments, the activity manager is used to manage the lifecycle of individual applications and the usual navigation fallback functionality.

In some embodiments, the window manager is used to manage all window operations associated with applications.

In some embodiments, the system runtime layer provides support for the upper layer, i.e., the framework layer, and when the framework layer is accessed, the Android operating system runs the C/C++ library contained in the system runtime layer to implement the functions to be implemented by the framework layer.

In some embodiments, the kernel layer is the layer between hardware and software. As shown in FIG. 4, the kernel layer contains at least one of the following drivers: audio driver, display driver, Bluetooth driver, camera driver, WIFI driver, USB driver, HDMI driver, sensor driver (such as fingerprint sensor, temperature sensor, touch sensor, pressure sensor, etc.).

In some embodiments, the kernel layer also includes a power drive module for power management.

In some embodiments, the software applications and/or modules corresponding to the software architecture in FIG. 4 are stored in the first or second memory shown in FIG. 2 or FIG. 3.

Based on the above-mentioned display apparatus 200, media resources such as video and audio can be played. When the display apparatus 200 plays media resources such as video and audio, which can be presented through a browser. A plurality of applications (Applications, APPs) can be deployed in the display apparatus 200, and the applications can also present media resource data through a browser. For example, the display apparatus 200 can present an application interface of media resource play through a browser, a plurality of media resource options can be included in the application interface of media resource play, and the user can control the browser to play corresponding media resource content by clicking any media resource option.

In some embodiments, after the user starts the browser on the display apparatus 200, some media resources can be loaded through the browser. When accessing a webpage or viewing media resources through a browser in the display apparatus 200, in order to improve the user's viewing experience, the toolbar in the browser can be hidden, so that the user can view an interface with wider range. The shortcut to browse media resources can be added in the browser in order to achieve quickly viewing webpages. For example, the webpage access addresses of various media resources can be added to the browser webpage in the form of links, so that when the user wants to watch the media resource, he/she can directly click the shortcut in the webpage to browse the content of the media resource.

However, after the user selects a media resource to be played, the browser will load the media resource, and the user cannot see the content of the media resource, i.e., the image of the media resource play, until the media resource is loaded. If the network loads too slowly or the network is interrupted, the browser loading speed will also be affected. Therefore, in the process of loading media resources through the browser, the user cannot know the progress of media resource loading, do not know when the loading will be completed, and when he/she will be able to watch the media resources, so the user can only wait aimlessly, which will affect the user experience.

In view of the issue that the user cannot know the progress of media resource loading, which affects the user experience in the process of loading media resources through a browser, some embodiments of the present disclosure provide a display apparatus 200. The display apparatus 200 includes a display and at least one processor wherein the display is configured to present an image from broadcast system or network and/or a user interface and the at least one processor is configured to perform a method of loading a webpage through a browser. When a webpage is accessed through a browser, regardless of whether the toolbar of the browser is presented, the display apparatus can present the webpage loading progress, and provides a user with a friendly loading progress prompt. Moreover, when the user performs the operation of continuously clicking or moving the cursor, the display apparatus 200 can predict the user's operation and provide the user with a prompt message, so that the user can perform a shortcut operation based on the prompt message, and then solve the problem that the user cannot know the progress of the media resource loading, which affects the user experience in the process of loading media resources in the browser.

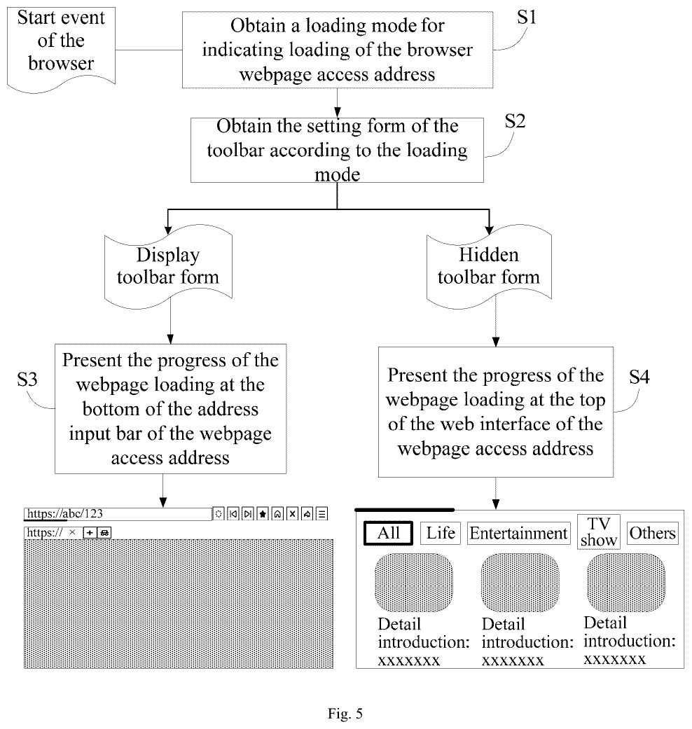

In order to facilitate the understanding of the embodiments in the present disclosure, steps are described in detail below in combination with some specific embodiments and accompanying drawings. FIG. 5 is a schematic diagram of a flow of a method for a display apparatus loading a webpage via a browser according to some embodiments of the present disclosure. As shown in FIG. 5, in some embodiments, when the display apparatus 200 performs the method of loading a webpage through a browser, which may include the following steps S1-S4, and the specific content is as follows.

Step S1: in response to a start event of a browser in the display apparatus, the display apparatus obtains a loading mode for indicating loading of the browser webpage access address.

In order to facilitate the user to perform different loading modes for the browser, in some embodiments, the display apparatus 200 can control the display 260 to present a mode switching control, the mode switching control can be used to switch the loading mode of the browser, then obtains the initial loading mode in which the browser is loaded, and in response to a mode switch command issued based on the mode switching control, the display apparatus 200 switches the initial loading mode to a target loading mode.

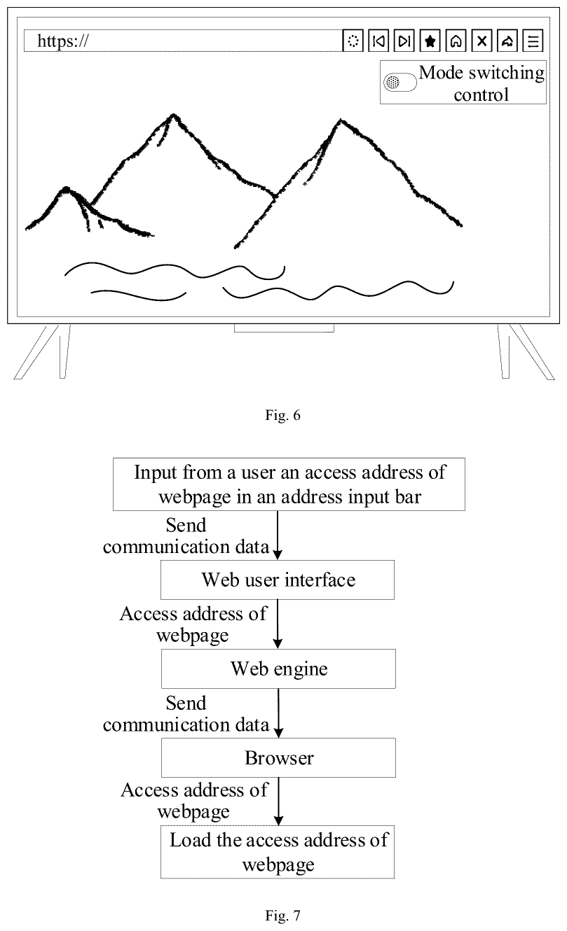

FIG. 6 is a schematic diagram of a scenario of switching a loading mode of a browser according to some embodiments of the present disclosure. As shown in FIG. 6, in some embodiments, a mode switching control can be arranged in the browser page. For example, a toolbar can be set in the home interface of the browser, and a mode switching control can be set in the next-level menu of the toolbar, that is, the display 260 is controlled to present the mode switching control. When the browser is just started, there will be an initial loading mode, for example, the initial loading mode can be a normal loading mode. When the user clicks the mode switching control, the display apparatus 200 will generate a mode switch command, the display apparatus 200 will switch the initial loading mode to a target loading mode based on this command, for example, the target loading mode can be an extremely-fast loading mode. In this way, different loading modes can be switched through the mode switching control, such as the way of sliding switching, or the way of clicking switching, etc., so that it is convenient for users to set different loading modes according to different needs.

There will be multiple configuration items set in the browser, and the configuration items will correspond to configuration data. It can be understood that the loading mode is also one of the configuration data. In some embodiments, the display apparatus 200 can obtain the loading mode and the configuration data for configuring the browser, and then obtain the user account state in the browser, wherein the user account state may include the logged-in state and the non-login state. If the user account state is the logged-in state, the display apparatus 200 can save the loading mode and configuration data to the cloud. If the user account state is the non-login state, the display apparatus 200 can save the loading mode and configuration data locally in the display apparatus.

For example, when the user account is logged in, after the loading mode of the browser is set, the display apparatus 200 can store the configuration data such as the loading mode, the homepage of the setting, the version information, and the historical information of the browser to the cloud. When the user account is not logged in, the display apparatus 200 can also store the above data, but the storage location is different not in the cloud, but in the display apparatus. When the user account is not logged in, the above data can be stored locally, e.g., stored in the cached space of the browser. In other words, when the user account is logged in, the setting contents for the browser can be uploaded to the cloud through the network protocol interface, and when the user account is not logged in, there is no need to be uploaded to the cloud. In this way, after the loading mode is saved, the last saved loading mode can be called when the browser is loaded, that is, the loading mode by which the browser loads webpage access address is obtained. After step S1 is executed, the following step S2 can be performed.

Step S2: the display apparatus obtains the setting form of the toolbar according to the loading mode.

After the loading mode is determined, the display apparatus can obtain the setting form of the toolbar according to the loading mode, wherein the setting form of the toolbar may include the display toolbar form and the hidden toolbar form. In some embodiments, the loading mode of the browser may include a normal loading mode and an extremely-fast loading mode, and the display apparatus 200 can set different display modes according to different loading modes.

For example, when the browser is in the normal loading mode, the homepage interface and the webpage interface of the browser can be presented at the same time, wherein the homepage interface may include a toolbar and related setting items, that is, the toolbar in the browser can be set in a display toolbar form. However, when the browser is in fast loading mode, the toolbar cannot be seen visually, and only the full-screen web interface can be seen, that is, the toolbar is set in a hidden toolbar form. In this way, the setting form of the toolbar can be obtained according to the loading mode, which will be described below for the progress bar display forms of the display toolbar form and the hidden toolbar form. After step S2 is complete, step S3 is implemented as follows.

Step S3: if the setting form is a display toolbar form, the display apparatus presents the progress of the webpage loading at the bottom of the address input bar of the webpage access address.

Through step S2, it can be seen that the loading mode of the browser can include the normal loading mode and the extreme-fast loading mode, and correspondingly, the setting form of the toolbar can include the display toolbar form and the hidden toolbar form. When the setting form of the toolbar in the browser is the display toolbar form, the display apparatus 200 can present the progress of the webpage loading at the bottom of the address input bar of the webpage access address.

In order to present the progress of the webpage loading at the bottom of the address input bar of the webpage access address, in some embodiments, in response to the loading mode being the normal loading mode, the display apparatus 200 can traverse the address input bar of the webpage access address, so that the bottom of the address input bar can be identified, then the communication progress of loading the webpage access address is obtained and the loading percentage parameter of loading the webpage access address is calculated according to the communication progress, and then the progress bar of the webpage loading is rendered according to the loading percentage parameter, and finally a progress bar is presented at the bottom of the address input bar.

For example, when the loading mode of the browser is the normal loading mode, after the user enters the webpage access address in the address input bar, the communication data can be sent, and the display apparatus 200 can obtain the webpage access address accessed by the user through the web user interface such as WEBUI. FIG. 7 is a schematic diagram of a flow of a display apparatus performing a webpage loading process according to some embodiments of the present disclosure. As shown in FIG. 7, after the web user interface obtains the webpage access address from the user, the web user interface can send the webpage access address to the web engine, and then the web engine transmits the webpage access address to the browser, so that the webpage access address is loaded by the browser. In this way, the web interface corresponding to the address of the webpage can be accessed via the browser.

In some embodiments, the display apparatus 200 can also obtain the loading state of a webpage access address in the browser, and present the progress of the webpage loading according to the loading state. For example, when a webpage starts loading, different loading states can be delivered. Referring to Table 1, Table 1 is a description table of the loading state of the webpage loaded by the browser according to some embodiments of the present disclosure.

TABLE 1
loading state of webpages loaded by browsers.

| Loading state | State identification | Related parameter |
|---|---|---|
| Loading start state | loadingstarted | None |
| Loading progress state | loadingprogress | Loading percentage |
| | | parameter |
| Loading finish state | loadingfinished | None |
| Webpage loading failure | loadingfailed | None |
| state | | |
| Webpage loading return | loadingblocked | None |
| state | | |

In some embodiments, the loading state of the browser loading webpage may include the loading start state, the loading progress state, the loading finish state, the webpage loading failure state, and the webpage loading return state, and the corresponding state identifiers are shown in Table 1. In different stages of browser loading webpage, above-mentioned loading state and corresponding state identification can be delivered, and according to the different loading states, the display apparatus 200 renders different forms of webpage loading progress whole loading process.

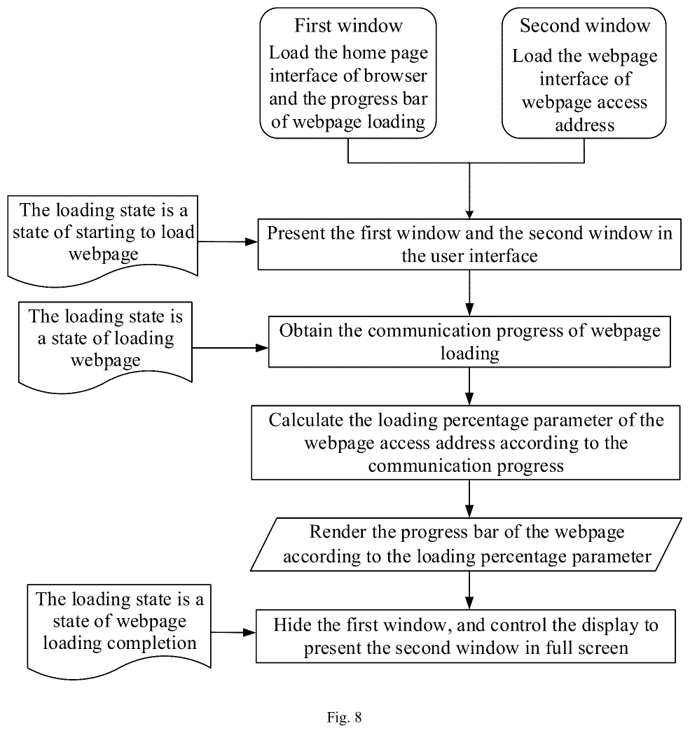

FIG. 8 is a schematic diagram of the process of presenting the loading progress of a webpage according to the loading state according to the display apparatus of some embodiments of the present disclosure in the normal loading mode, as shown in FIG. 8, when the loading mode of the browser is an normal loading mode, in order to present the progress of the webpage loading according to the loading state, the display apparatus 200 can be provided with a first window and a second window, wherein the first window can be used for loading the homepage interface of the browser and the progress bar of the webpage loading, and the second window can be used for loading the webpage interface of the webpage access address. The display apparatus 200 can control the display 260 to present the first window and the second window in the user interface, in response to the loading state being the loading progress state, the display apparatus 200 can obtain the communication progress of the webpage loading, calculate the loading percentage parameter of the webpage access address according to the communication progress, and render the progress bar of the webpage according to the loading percentage parameter. In response to the loading state being the loading finish state, the display apparatus 200 can hide the first window, and control the display 260 to present the second window in full screen to present the web interface in the user interface in full screen.

When the loading mode of the browser is the normal loading mode, the display apparatus 200 can use the mode of double windows, that is, the first window and the second window are set. The user interface of the browser's homepage, such as WEBUI, can occupy one window, and the web interface corresponding to the webpage access address to be loaded can occupy another window.

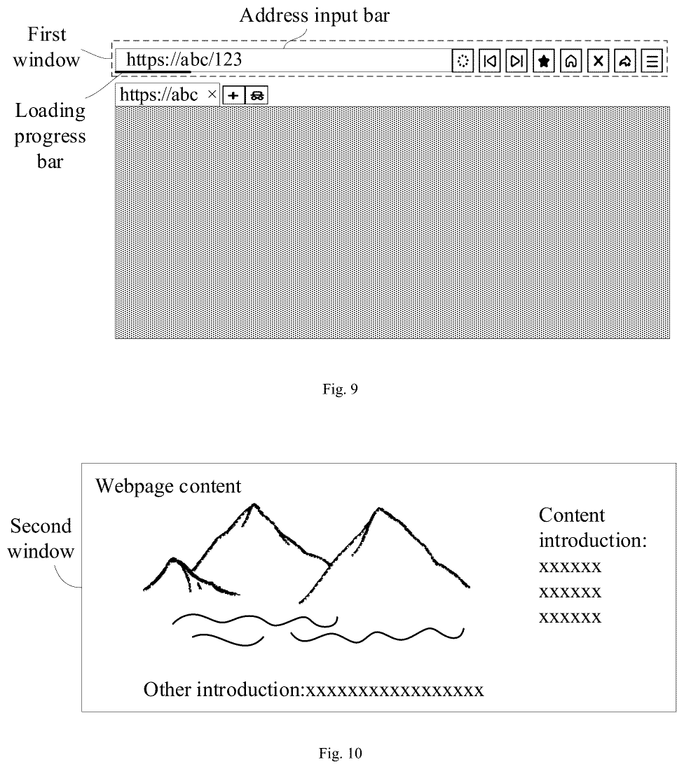

FIG. 9 is a schematic diagram of an effect of a browser homepage interface in a first window according to some embodiments of the present disclosure. FIG. 10 is a schematic diagram of an effect of a web interface in a second window according to some embodiments of the present disclosure. In some embodiments, referring to FIG. 9 and FIG. 10, the display level of the first window is higher than the display level of the second window, so that the toolbar and the progress bar of the browser can be presented at the top of the first window, that is, the webpage interface.

In order to realize that different loading modes are presented different display modes, in the process of webpage loading, when user interface WEBUI receives the message that the loading state is started, the display apparatus 200 can present the first window and the second window simultaneously, e.g., the upper display toolbar as shown in FIG. 9, and the lower display webpage interface as shown in FIG. 10. When the user interface WEBUI receives the communication state of the loading state, the loading speed of the webpage can be presented according to the percentage of the communication progress received, such as the loading percentage parameter, and the progress bar of the webpage loading can be rendered according to the loading percentage parameter, as shown in the webpage loading progress bar in FIG. 9, so that the user can know the progress of the current webpage loading according to the length of the progress bar, without waiting aimlessly.

When webpage loading is completed, the user interface WEBUI can receive the communication message of loading finish state, and when loading is completed, the display apparatus 200 can hide the first window, that is, hide toolbar, progress bar, etc., so that webpage interface can be presented in full screen after loading is completed. That is to say, when the toolbar in the browser is not hidden, the webpage loading progress can be presented inside the address input bar, such as at the bottom, to give the user an indication of the current webpage loading progress, so as to solve the problem that the user cannot know the progress of media resource loading in the process of loading media resources through the browser. After step S3 is complete, the flow goes to step S4.

Step S4: if the setting form is a hidden toolbar form, the display apparatus 200 presents the progress of the webpage loading at the top of the web interface of the webpage access address.

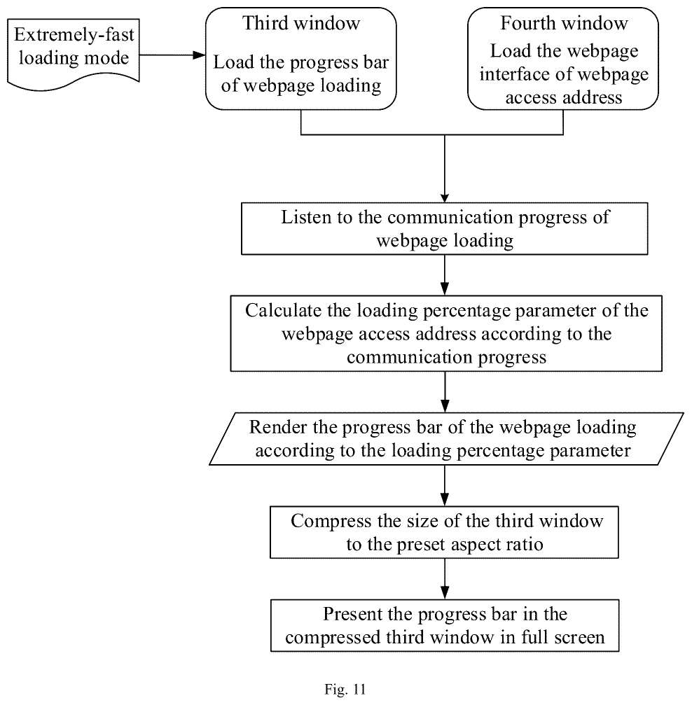

When the loading mode of the browser is the extremely-fast loading mode, and the setting form of the toolbar is the hidden toolbar form, the display apparatus 200 can present the progress of the webpage loading at the top of the webpage interface of the webpage access address. FIG. 11 is a schematic diagram of a flow of presenting a webpage loading progress at a top of a webpage interface of webpage access address in the display apparatus according to some embodiments of the present disclosure. As shown in FIG. 11, in some embodiments, when the display apparatus presents the webpage loading progress of webpage at the top of webpage interface of webpage access address, in response to the loading mode of the browser being the extremely-fast loading mode, and the display apparatus 200 can first set the third window and the fourth window, wherein the third window is used for loading the progress bar of webpage loading, the fourth window is used to load the web interface of the webpage access address, and the display level of the third window is higher than that of the fourth window, which means that the presentation of the third window has a higher priority than the presentation of the fourth window. During display of the user interface on the display, the third window in a first layer may be displayed above the fourth window in a second layer located under the first layer in the user interface comprising multiple layers. After that, the display apparatus 200 can monitor the communication progress of the webpage loading, calculate the loading percentage parameter of the webpage access address according to the communication progress, render the progress bar of the webpage loading according to the loading percentage parameter, and then compress the size of the third window to a preset aspect ratio, and finally present the progress bar in the compressed third window in full screen.

For example, when the loading mode of the browser is extremely-fast loading mode, the display apparatus 200 can also use the double-window mode, that is, set the third window and the fourth window. The third window at the top is used to load the progress bar, and the fourth window at the top is used to load the web interface. In the process of loading webpage, the display apparatus 200 can listen to the communication progress of webpage loading, calculate the percentage parameter of webpage loading according to the communication progress, and render the progress bar presented in the third window according to the percentage parameter.

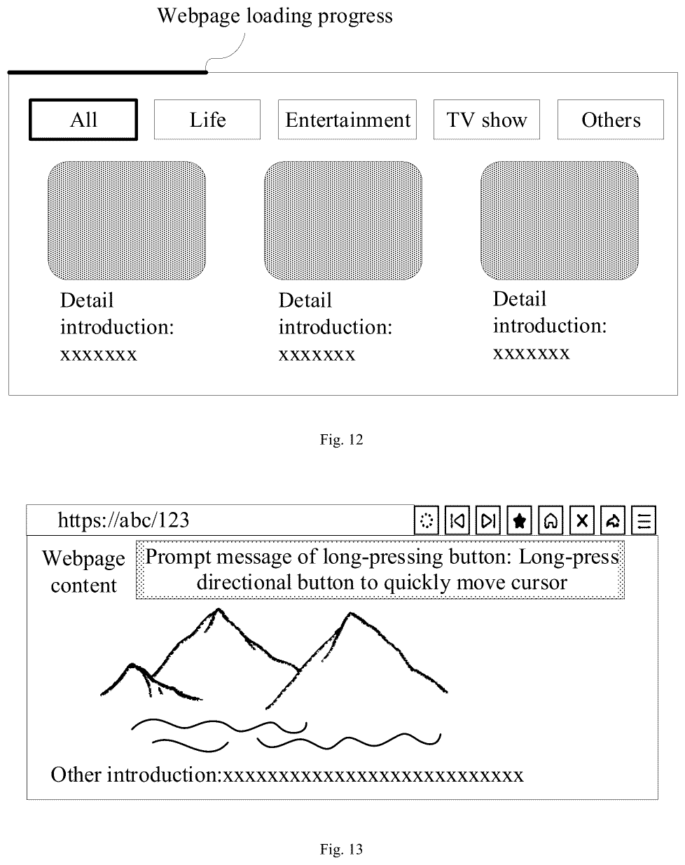

FIG. 12 is a schematic diagram of an effect of presenting a webpage loading progress in an extremely-fast loading mode in the display apparatus according to some embodiments of the present disclosure. As shown in FIG. 12, a progress bar is arranged at the top of the webpage interface, this progress bar is obtained after calculating the webpage loading percentage parameter according to the communication progress and rendering, and this progress bar occupies the position of the third window. That is, when the progress bar is presented, the size of the third window is compressed, for example, the height of the third window is the same as the width of the progress bar, that is, the progress bar occupies 100% of the height of the third window. Visually, only the progress bar exists in the third window, the fourth window presents the web interface in full screen, and the progress bar is set at the top of the web interface. In this way, when the toolbar is in a hidden state, for the prompt of webpage loading progress, the progress bar can be presented in the built-in way of the webpage. For example, when the tool bar is in a hidden state, the progress bar is built into the third window, and the progress bar is presented in full screen in the third window, and the user is given an indication of the progress of the current webpage loading through the built-in progress bar, so as to solve the problem that the user cannot know the progress of media resource loading in the process of loading media resources through the browser.

When the browser loads the webpage, it can obtain the loading mode of the browser and the setting form of the browser toolbar. When its setting form is the display toolbar form, the webpage loading progress can be presented inside the address input bar, and when it is set in the hidden toolbar form, the webpage loading progress can be presented in the built-in mode of the webpage. That is to say, in the embodiments of the present disclosure, for the loading modes of different browsers, prompts with different webpage loading progress can be set, so as to prompt the user with the progress of the current webpage loading, and solve the problem that the user cannot know the progress of media resource loading, which affects the user experience in the process of loading media resources in the browser.

When the browser completes loading the webpage, the user may move the webpage up and down or perform functions such as page turning. In order to facilitate the user's operation, the display apparatus 200 can also predict the user's operation, and give the user corresponding prompt information.

In some embodiments, the display apparatus 200 can obtain the number of consecutive clicks from the user on the direction key. If the number of consecutive clicks exceeds a threshold, the display apparatus 200 generates a long press prompt message. The long-press prompt message is used for prompting to move the cursor by long-pressing the direction key, and the long-press prompt message is presented at a preset position.

When the user accesses the web interface, the display apparatus 200 can detect the number of consecutive clicks on the directional keys. In some embodiments, the number threshold may be five times, and FIG. 13 is a schematic diagram of a scenario where a display apparatus generates a long pressing button prompt message according to some embodiments of the present disclosure. As shown in FIG. 13, if the user clicks a key in the same direction button five times, the display apparatus 200 can prompt the user to press and hold the operation by generating a long pressing key prompt message. In this way, when the user performs a page turning operation on the webpage, he/she can quickly turn the page by pressing and holding it.

In some embodiments, the display apparatus 200 can also obtain the top edge position and the bottom edge position of the webpage interface, and detect the cursor position of the cursor of the direction key in the webpage. If the distance between the cursor position and the top edge position is within the preset distance threshold range, or, the distance between the cursor position and the bottom edge position is within the preset distance threshold range, a quick page-turning prompt message is generated, and the quick page-turning prompt message is used for prompting the page turning function to be performed by the page turning shortcut.

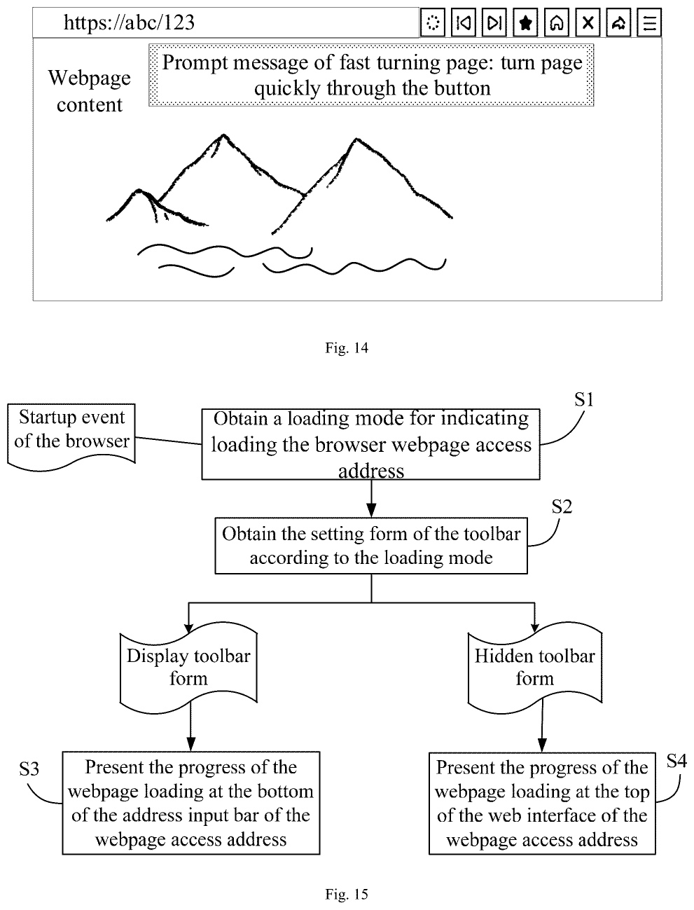

FIG. 14 is a schematic diagram of a scenario where a display apparatus generates a page-turning prompt message according to some embodiments of the present disclosure. As shown in FIG. 14, when a user accesses a webpage interface and realizes a page-turning function through an arrow key, if the distance between the cursor position and the top edge of the webpage interface is within the preset distance threshold range, or the distance between the cursor position and the bottom edge is within the preset distance threshold range, it indicates that the user may want to perform the function of turning the page, and the user can be reminded to perform the page-turning function by the shortcut key for turning the page in this case. In this way, when the user sees the prompt message, he can use the page turning shortcut button to perform the function of turning the page quickly, without moving the cursor step by step, which can improve the efficiency of page turning.

The above embodiments provide the display apparatus, in which, in response to the start event of the browser, the display apparatus 200 obtains a loading mode for indicating loading of the browser webpage access address, and obtains the setting form of the toolbar according to the loading mode, wherein the setting form includes a display toolbar form and a hidden toolbar form. If the setting form is a display toolbar form, the display apparatus 200 presents the progress of the webpage loading at the bottom of the address input bar of the webpage access address, and if the setting form is a hidden toolbar form, the display apparatus 200 presents the webpage loading progress at the top of the webpage interface of the webpage access address. When accessing a webpage through a browser, regardless of whether the toolbar of the browser is presented or not, the display apparatus 200 can present the progress of the webpage loading, and provide users with a friendly loading progress prompt. Moreover, when the user performs the operation of continuously clicking or moving the cursor, the display apparatus 200 can predict the user's operation and provide the user with a prompt message, so that the user can perform a shortcut operation based on the prompt message, and then solve the problem that the user cannot know the progress of the media resource loading, which affects the user experience in the process of loading media resources in the browser.

Some embodiments of the present disclosure also provide a method of loading a webpage through a browser, and FIG. 15 is a schematic diagram of a flow of a method of loading a webpage through a browser according to some embodiments of the present disclosure. As shown in FIG. 15, in some embodiments, the method of loading a webpage through a browser may include the following steps S1-S4.

Step S1: in response to a start event of a browser in the display apparatus, the display apparatus obtains a loading mode for indicating loading of the browser webpage access address.

In order to facilitate the user to perform different loading modes to the browser, in some embodiments, the display apparatus 200 may be provided with a mode switching control, and the mode switching control can be used to switch the loading modes for the browser, after which the initial loading mode loaded by the browser can be obtained, and in response to the mode switch command issued based on the mode switching control, the display apparatus 200 switches the initial loading mode to the target loading mode.

Step S2: the display apparatus obtains the setting form of the toolbar according to the loading mode.

After the loading mode is determined, the display apparatus 200 can obtain the setting form of the toolbar according to the loading mode, wherein the setting form may include the display toolbar form and the hidden toolbar form. In some embodiments, the loading mode of the browser may include a normal loading mode and an extremely-fast loading mode, and the display apparatus 200 can set different display modes according to different loading modes.

When the browser is in the normal loading mode, the homepage interface and webpage interface of the browser can be presented at the same time, wherein the homepage interface may include toolbars and related setting items, that is, the setting form of the toolbar in the browser is the display toolbar form. However, when the browser is in the extremely-fast loading mode, the toolbar cannot be seen visually, and the full-screen web interface can only be seen, that is, the toolbar is set in the hidden toolbar form. In this way, the setting form of the toolbar can be obtained according to the loading mode.

Step S3: if the setting form is a display toolbar form, the display apparatus presents the progress of the webpage loading at the bottom of the address input bar of the webpage access address.

In order to present the webpage loading progress at the bottom of the address input bar of the webpage access address, in some embodiments, in response to the loading mode being the normal loading mode, the display apparatus 200 can traverse the address input bar of the webpage access address, so that the bottom of the address input bar can be identified, and then the communication progress of loading the webpage access address is obtained, and the loading percentage parameter of loading the webpage access address is calculated according to the communication progress, and then the progress bar of the webpage loading is rendered according to the loading percentage parameter, and finally, a progress bar is presented at the bottom of the address input bar.

Step S4: if the setting form is the hidden toolbar form, the display apparatus 200 presents the progress of the webpage loading at the top of the web interface of the webpage access address.

When the loading mode of the browser is the extremely-fast loading mode, and the setting form of the toolbar is the hidden toolbar form, the display apparatus 200 can present the progress of the webpage loading at the top of the webpage interface of the webpage access address. In some embodiments, when the display apparatus 200 presents the webpage loading progress at the top of the webpage interface of the webpage access address, in response to the loading mode of the browser being the extremely-fast loading mode, the display apparatus 200 can first set a third window and a fourth window, wherein the third window is used for loading the progress bar of webpage loading, the fourth window is used for loading the webpage interface of the webpage access address, and the display level of the third window is higher than the display level of the fourth window. After that, the display apparatus 200 can listen to the communication progress of the webpage loading, calculate the loading percentage parameter of the webpage access address according to the communication progress, render the progress bar of the webpage loading according to the loading percentage parameter, and then compress the size of the third window to the preset aspect ratio, and finally present the progress bar in the compressed third window in full screen.

When the browser loads the webpage, it can obtain the loading mode of the browser and the setting form of the browser toolbar, when its setting form is the display toolbar form, the webpage loading progress can be presented inside the address input bar, and when it is set in the hidden toolbar form, the webpage loading progress can be presented in the built-in mode of the webpage. That is to say, in the embodiments of the present disclosure, for the loading modes of different browsers, prompts with different webpage loading progress can be set, so as to prompt the user with the progress of the current webpage loading, and solve the problem that the user cannot know the progress of media resource loading, which affects the user experience in the process of loading media resources in the browser.

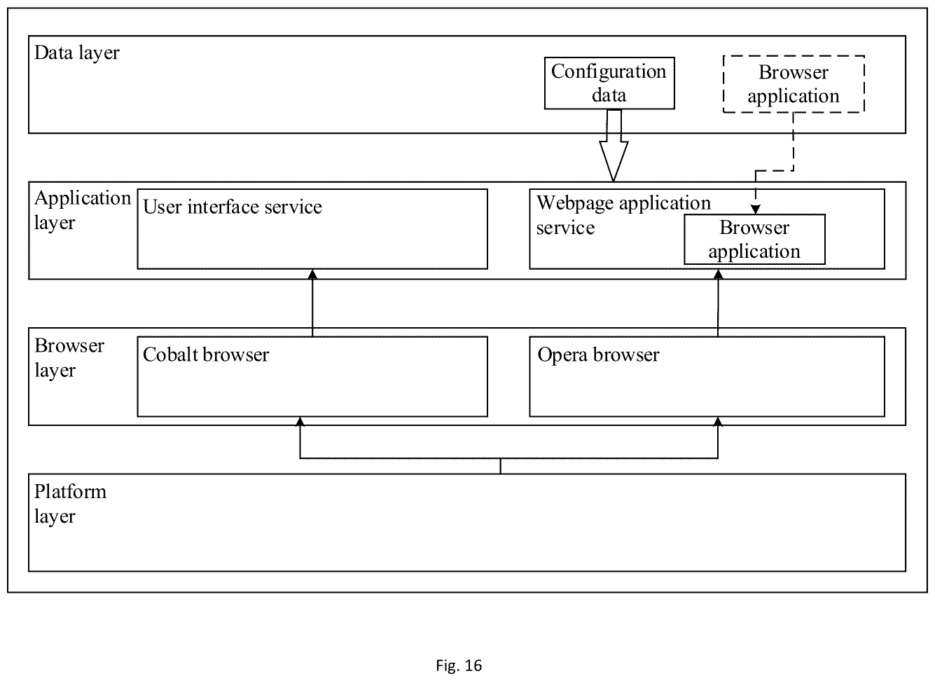

The above embodiments provide the method for loading the webpage through the browser, including, in response to a start event of the browser, obtaining the loading mode for the browser to load a webpage access address, and obtaining the setting form of the toolbar according to the loading mode, if the setting form is the display toolbar form, the webpage loading progress is presented at the bottom of the address input bar of the webpage access address, and if the setting form is the hidden toolbar form, the webpage loading progress is presented at the top of the webpage interface of the webpage access address. When the webpage is accessed through the browser, regardless of whether the browser's toolbar is presented or not, this method can present the progress of the webpage loading to provide users with an indication of the loading progress. In addition, when the user performs the operation of continuously clicking or moving the cursor, the user's operation can be predicted and the user can be provided with the prompt message, so as to solve the problem that the user cannot know the progress of the media resource loading in the process of loading media resources in the browser, which affects the user experience. Taking the display apparatus is a television as an example, FIG. 16 is an architecture diagram of a display control system according to some embodiments of the present disclosure. As shown in FIG. 16, the display control system 400 may include a platform layer, a browser layer, an application layer, a data layer from bottom to top.

Here, the platform layer is the core part of the TV operating system, which can provide functions such as the user interface, application management, resource scheduling, and hardware control, etc.

The browser layer can provide support for browser applications in TVs, for example, browser applications can include the Cobalt browser and Opera browser, etc. The Cobalt Browser is a web browser designed for Android TV devices. It supports HTML5 (a language description of web content), JavaScript (a function-first, lightweight, interpreted, or just-in-time compiled programming language) and other web technologies, and is optimized for TV screens, making it easy for users to browse web content on their TV. The Cobalt browser is usually pre-installed by device manufacturers in their Android TV products for access to the Internet and online content. It provides a fast, secure, and personalized Internet experience with powerful features and scalability.

With fast page loading speeds and smooth web navigation, the Opera browser can provide read/write interfaces, resolution interfaces, basic data interfaces, and signal/authentication interfaces. It uses multi-threading technology and data compression algorithms to speed up webpage loading and reduce data consumption, which is suitable for browsing on slow web environments, and the Opera browser has built-in features such as an ad blocker, privacy protection mode, VPN service, shortcut key operation, etc.

The application layer can provide user interface services and web application services. As shown in the figures, the user interface services can include functions such as drivers, networks, application control, and accounts, and web application services can include TV browsers, etc.

When the user controls the browser application through the user interface, the TV opens the browser application and responds to the control operation through the browser layer and the platform layer, thereby controlling the browser application to present the corresponding page or perform the corresponding configuration operation.

The data layer can be used to store the configuration data of the TV, such as the configuration data of the TV browser. When the user has set up operations on the TV, the operation data will be synchronized and stored in the data layer.

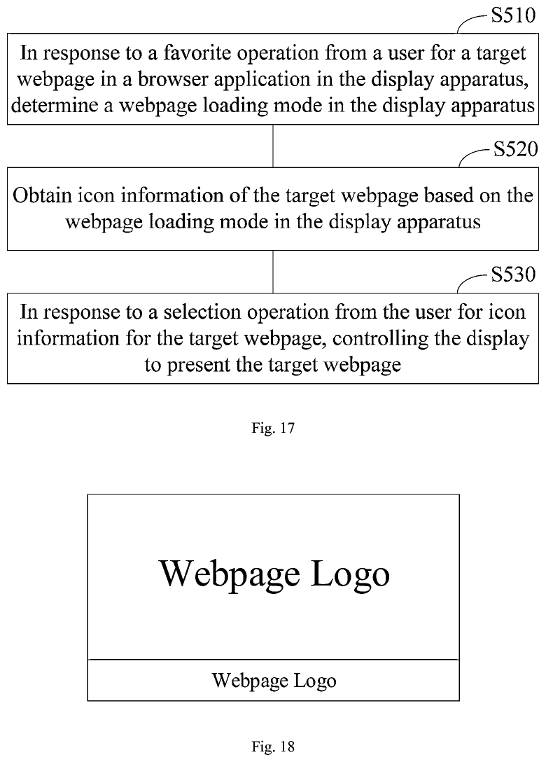

The following is described in detail in combination with accompanying FIG. 17 for a display control method based on the display apparatus according to some embodiments of the present disclosure.

The display control method according to some embodiments of the present disclosure can be applied to the display apparatus 200 shown in FIG. 1.

Here, the display 260 of the display apparatus 200 can also be used for presenting a corresponding page from the browser application, such as presenting the homepage of the browser application, and also presenting a plurality of pages in the browser application that the user opens. The communicating device 220 may be used to receive user operations, for example, the communicating device 220 can receive the user's input to switch pages of a browser application, and can also receive the user's input to favorite a certain webpage in a favorite browser application.

According to the display control method according to the embodiments, the display apparatus may, in response to a favorite operation from the user for a target webpage in the browser application, determine the webpage loading mode in the display apparatus, obtain the icon information of the target webpage based on the webpage loading mode in the display apparatus, and in response to a selection operation from the user for the icon information of the target webpage, control the display to present the target webpage. When the user chooses to favorite the webpage, the display apparatus can obtain the icon information of the webpage, so that the user can control the display apparatus to quickly enter the target webpage through the icon information of the target webpage, and the display can present the target webpage, which can improve the speed of the display apparatus loading and presenting the webpage of the website, and improve the user experience.

As shown in FIG. 17, the display apparatus is configured to execute the instructions to cause the display apparatus to perform the following steps S510˜S530.

Step S510: in response to a favorite operation from a user for a target webpage in a browser application in the display apparatus, determining a webpage loading mode in the display apparatus.

Here, the webpage loading mode in the display apparatus includes a first loading mode and a second loading mode, and the webpage loading speed when the display apparatus is in the first loading mode whose loading speed is smaller than the webpage loading speed when the display apparatus is in the second loading mode. The target page can be any webpage for the browser application.

The webpage loading mode of the display apparatus refers to the mode in which the webpage is opened by the display apparatus. In this embodiment, the display apparatus may provide two webpage loading modes, namely the first loading mode and the second loading mode, wherein the webpage loading speed is faster when the display apparatus is in the second loading mode. In other words, the webpage loading mode in the display apparatus can be used to control the speed at which the display apparatus loads the pages of the browser application, which can be set by the users according to their own needs, or can be automatically switched by the display apparatus according to the type of webpage in the browser application which is running on the display apparatus.

Depending on how the display apparatus is controlled, a favorite operation from the user for a target page in a browser application can be generated in different ways. For example, when a browser application is running and controlled in the at least one processor and the target page is presented on the display, the user can select the presented “Web Favorite” control to issue a favorite operation for the target page, or the user can also issue a favorite operation for the target page by using a corresponding shortcut key, such as selecting both “Ctrl” and “D” at the same time.

When the favorite operation from the user for the target page in the browser application is received, the at least one processor can, in response to the favorite operation, determine the webpage loading mode in the display apparatus at the current moment. For example, the at least one processor may determine whether the display apparatus has the first loading mode or the second loading mode turned on at the current moment when receiving a favorite operation input from the user, so as to determine the webpage loading mode of the display apparatus.

Through the above-mentioned method, the user can favorite the webpage according to his/her own needs, and the at least one processor can, in response to the favorite operation from the user, determine the webpage loading mode in the display apparatus.

Step S520: obtaining icon information of the target webpage based on the webpage loading mode in the display apparatus.

In this embodiment, the icon information of the target webpage is used as a shortcut entry to access the target webpage, and may include information required to load the target webpage, such as a webpage logo (logo), web address, loading script, and other information. In order to facilitate the user to view and select the icon information of the target webpage, the icon information can be presented at the recommendation bar of the homepage of the browser application. The recommendation bar may include a plurality of recommendation items columns, each recommendation column can present the icon information of one target webpage, or the icon information of the target webpage can also be set in the favorite bar of the browser application, and when the user selects a favorite bar, the at least one processor can control the display to call up the page of the favorite bar and present the icon information of each target webpage.

FIG. 18 is a schematic diagram of presenting for icon information according to some embodiments of the present disclosure, and it can be seen that the icon information of the target webpage can be presented as a graphic element including the logo of the target webpage.

It should be understood that the above icon information is only an illustration, and in addition to the webpage logo, URL, and loading script, the icon information may also include other information about loading the target webpage.

In order to facilitate the loading of the target webpage, the display apparatus can obtain the icon information of the target webpage according to the webpage loading mode in the display apparatus, so that the target webpage can be quickly loaded and presented through the icon information of the target webpage when receiving an operation from the user for loading the target webpage.

The at least one processor can determine the speed at which the display apparatus loads the webpage based on the webpage loading mode in the display apparatus, so as to obtain the icon information of the target webpage in a corresponding way. For example, when the display apparatus determines that the display apparatus is in the first loading mode according to the webpage loading mode in the display apparatus, the display apparatus can obtain the icon information of the target webpage when receiving the loading operation from the user for the target webpage, so as to load the target webpage through the icon information, and the webpage loading speed of the display apparatus is slower. When the display apparatus determines that the display apparatus is in the second loading mode according to the webpage loading mode in the display apparatus, the display apparatus can obtain the icon information of the target webpage when receiving the favorite operation from the user for the target webpage, so that the target webpage is loaded through the icon information of the target webpage when receiving the user's loading operation from the user for the target webpage, and the webpage loading speed of the display apparatus is faster in this case.

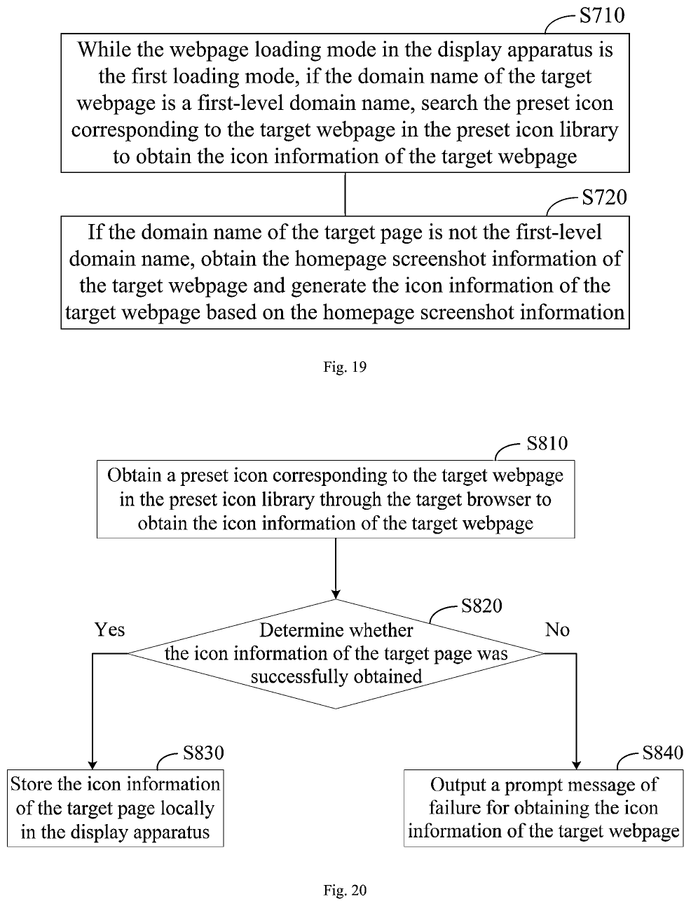

FIG. 19 is a flow chart of another display control method according to some embodiments of the present disclosure, and as shown in FIG. 19, the at least one processor may perform the following method.

Step S710: while the webpage loading mode in the display apparatus is the first loading mode, if the domain name of the target webpage is a first-level domain name, searching the preset icon corresponding to the target webpage in the preset icon library to obtain the icon information of the target webpage.

The first-level domain name is the highest-level part of a domain name structure that is usually used to identify a specific website or organization under a top-level domain. The first-level domain name follows the top-level domain, for example, in “example.com”, “.com” is the top-level domain and “example” is the first-level domain. The preset icon library is a pre-configured icon repository by developers, which can include the loading information of multiple webpages, such as webpage logos, URLs, loading scripts, and other information.

When the webpage loading mode in the display apparatus is the first loading mode, the display apparatus can determine whether the domain name of the target webpage is a first-level domain name to determine the way to obtain the icon information of the target webpage. Because the number of first-level domain names is limited, and the first-level domain name includes a globally common organization domain name, which has a certain universality, when the domain name of the landing page is a first-level domain name, the display apparatus can first search the preset icon corresponding to the target webpage in the preset icon library, for example, the display apparatus can search the preset icon corresponding to the web address in the preset icon library according to the URL of the target webpage, so as to obtain the icon information of the preset icon and obtain the icon information of the target webpage.

When searching the preset icons corresponding to the target page in the preset icon library, if the preset icon library is stored locally in the display apparatus, the preset icon library can be directly read and the preset icons corresponding to the target page can be searched in the preset icon library. If the preset icon library is not stored locally, the preset icon library can be obtained according to the corresponding acquisition method and the preset icon corresponding to the target webpage can be searched in the preset icon library. For example, the icon information of the target webpage can be obtained through the target browser. As shown in FIG. 20, the following steps can be included.

Step S810: obtaining a preset icon corresponding to the target webpage in the preset icon library through the target browser to obtain the icon information of the target webpage.

Here, the target browser can comprise the Odin browser, which is a browser based on the decentralized web ecological public chain.

For example, the display apparatus can pass an instruction to the Odin browser to obtain the icon information of the target webpage in the preset icon library, so that the Odin browser can, in response to the instruction, search the preset icon of the target webpage in the preset icon library, obtain the icon information of the target webpage, and then return the icon information of the target webpage to the processor.

Step S820: determining whether the icon information of the target page was successfully obtained, if so, the flow goes to step S830, and if not, the flow goes to step S840.

Step S830: storing the icon information of the target page locally in the display apparatus.

After the acquisition of the icon information of the target webpage is completed, the display apparatus can control the display apparatus to store the icon information of the target webpage locally in the memory space of the display apparatus for the user to view and select.

Step S840: outputting a prompt message of failure for obtaining the icon information of the target webpage.

If the icon information of the target webpage is not successfully obtained, in order to facilitate the user to understand the acquisition state of the icon information of the target webpage, the display apparatus may output a prompt message, such as presenting a prompt message on the display, which can be used to prompt the user that the icon information of the target webpage has failed to be obtained.

Through the above-mentioned method, the icon information of the target webpage can be obtained in the preset icon library through the target browser, and when the icon information of the target webpage cannot be obtained, the prompt information can also be output for the user to operate.

Step S720: if the domain name of the target page is not the first-level domain name, obtaining the homepage screenshot information of the target webpage and generating the icon information of the target webpage based on the homepage screenshot information.

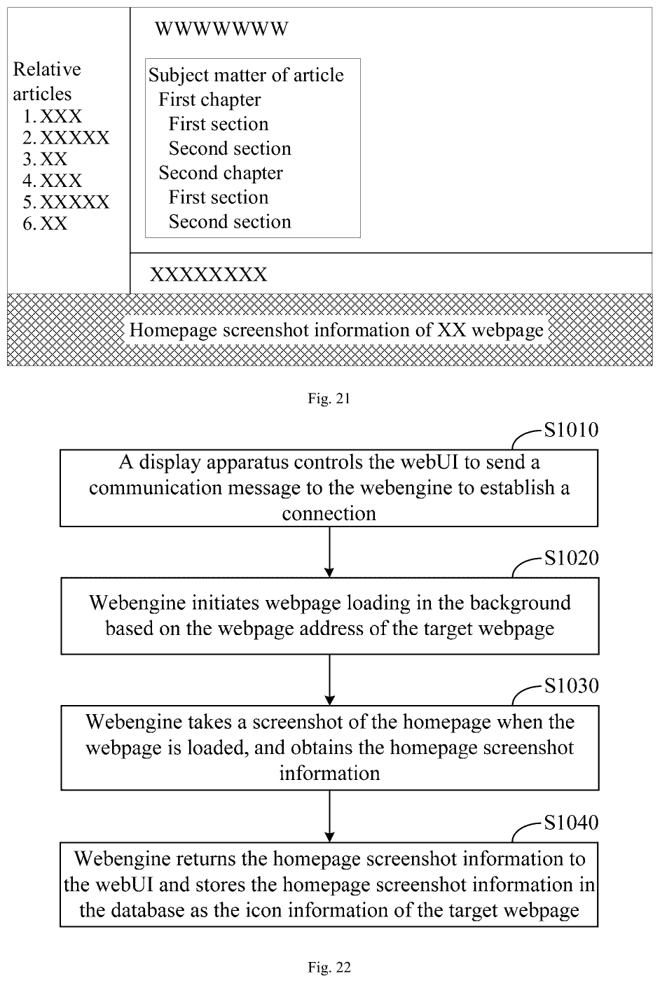

If the domain name of the target webpage is not a first-level domain name, the icon information of the target webpage cannot be found in the preset icon library. The display apparatus can obtain the homepage screenshot information of the target webpage, so that the homepage screenshot information is used as the logo of the target webpage, and takes other loading information of the target webpage together with the homepage screenshot information as the icon information of the target webpage. FIG. 21 is a schematic diagram of homepage screenshot information according to some embodiments of the present disclosure. As shown in FIG. 21, the homepage screenshot information can present general content of the webpage.

In some embodiments, referring to FIG. 22, the display apparatus obtains homepage screenshot information of the target web webpage via the following method.

Step S1010: a display apparatus controls the webUI (Web User Interface), that is, the web user interface sends a communication message to the webengine (a technology used to build the browser engine), to establish a connection.

Here, the communication message may include the user's operation information, such as the webpage address of the target webpage and the user's user information, such as the user's account, and the device identification of the terminal device, etc.

Step S1020: webengine initiates webpage loading in the background based on the webpage address of the target webpage.

Step S1030: webengine takes a screenshot of the homepage when the webpage is loaded, and obtains the homepage screenshot information.

Step S1040: webengine returns the homepage screenshot information to the webUI and stores the homepage screenshot information in the database as the icon information of the target webpage.

Through the method, the display apparatus can obtain the icon information of the target webpage through different ways according to whether the domain name of the target webpage is the first-level domain name, so that the user can obtain the icon information of the webpage when choosing to favorite a webpage, so that when the user needs to access the webpage, the webpage can be quickly accessed through the icon information, so that the loading speed of the webpage can be improved.

In some embodiments, if the preset icon corresponding to the target webpage is not found in the preset icon library, the display apparatus obtains the icon information of the target webpage through the target browser. Here, the target browser can be the Odin browser.

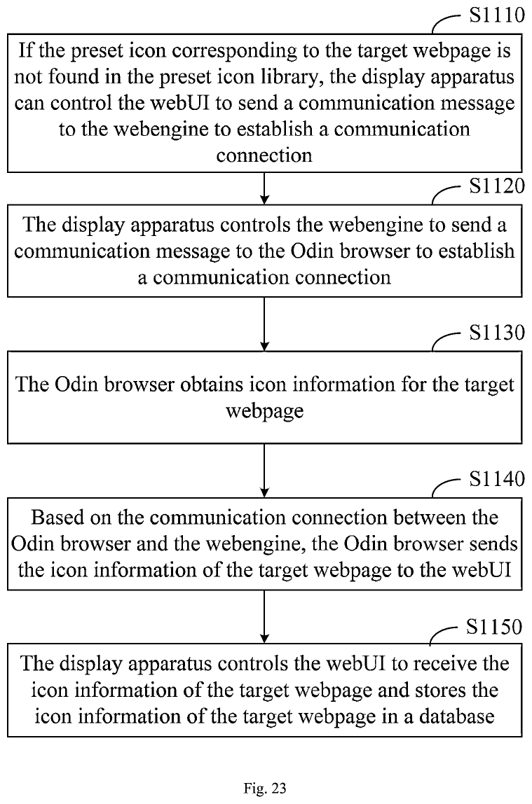

For example, the Odin browser can arrange a three-party communication with the webengine and the webUI, and when receiving the user's input to favorite a target webpage, the display apparatus can obtain the icon information of the target webpage based on the communication connection between the webUI and the webengine, and the communication connection between the webengine and the Odin browser. FIG. 23 is a flow chart of another display control method according to some embodiments of the present disclosure. As shown in FIG. 23, the method may specifically include the following steps.

Step S1110: if the preset icon corresponding to the target webpage is not found in the preset icon library, the display apparatus can control the webUI to send a communication message to the webengine to establish a communication connection.

The communication message may include the webpage information of the target webpage, such as the URL, or may only include the instruction information to establish the communication connection.

The Odin browser can capture the icon information of the webpage, so if there is no preset icon corresponding to the target webpage in the preset icon library, the display apparatus can obtain the icon information of the target webpage through the Odin browser. First, the display apparatus can control the webUI to send communication messages to the webengine to establish a communication connection between the webUI and the webengine.

Step S1120: the display apparatus controls the webengine to send a communication message to the Odin browser to establish a communication connection.

That is, the display apparatus can control the webengine to send communication messages to the Odin browser to establish a communication connection between the webengine and the Odin browser.

Step S1130: the Odin browser obtains icon information for the target webpage.

For example, the Odin browser can obtain the icon information of the target webpage based on the webpage information of the target webpage contained in the received communication message.

In some embodiments, the Odin browser can also receive the user's operation information, i.e., the operation information for favoriting target webpage, sent from the webUI through the webengine after establishing a communication connection with the webengine, so as to obtain the icon information of the target webpage in response to this information.

Step S1140: based on the communication connection between the Odin browser and the webengine, the Odin browser sends the icon information of the target webpage to the webUI.

Step S1150: the display apparatus controls the webUI to receive the icon information of the target webpage and stores the icon information of the target webpage in a database.

In this way, the icon information of the target webpage can be obtained through the target browser when the preset icon of the target webpage is not found in the preset icon library.

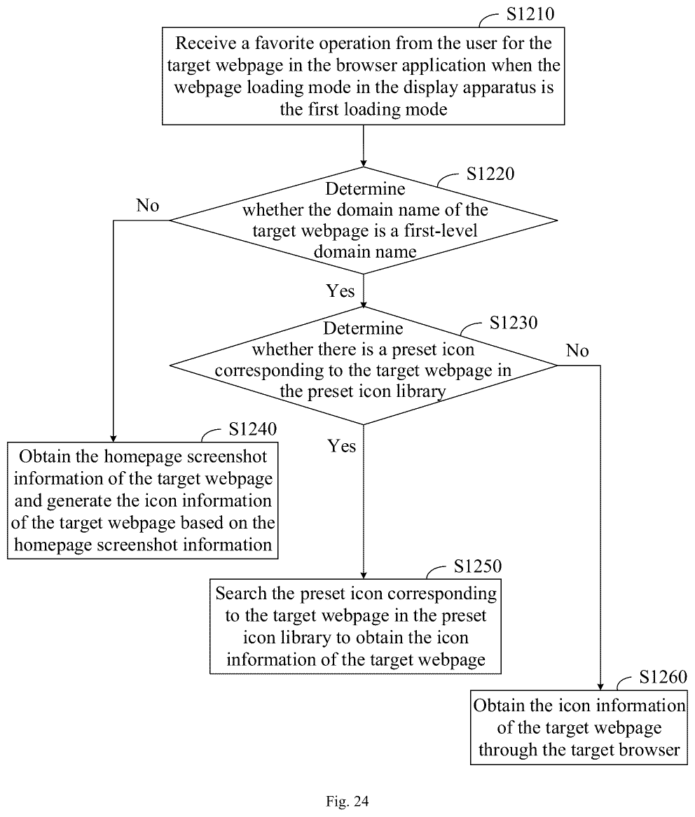

FIG. 24 is a flow chart of another display control method according to some embodiments of the present disclosure. As shown in FIG. 24, the method may include the following steps.

Step S1210: receiving a favorite operation from the user for the target webpage in the browser application when the webpage loading mode in the display apparatus is the first loading mode.

If the user sets the webpage loading mode to the first loading mode, the display apparatus can determine the webpage loading mode in the display apparatus. When receiving the favorite operation from the user for the target webpage in the browser application, the target webpage can be processed according to the webpage loading mode, such as first obtaining the icon information of the target webpage, and then controlling the display to present the target webpage when receiving the selection operation from the user for the icon information of the target webpage.

Step S1220: determining whether the domain name of the target webpage is the first-level domain name, if so, then the flow goes to step S1230, if not, the flow goes to step S1240.

The display apparatus can compare the domain name of the target webpage with the first-level domain name in the pre-stored first-level domain name database to determine whether the domain name of the target webpage is the first-level domain name, if so, there may be a preset icon corresponding to the target webpage in the preset icon library corresponding to the display apparatus, so step S1230 can be performed, if not, the domain name of the target webpage has no pre-configured icon information, so step S1240 can be performed.

Step S1230: determining whether there is a preset icon corresponding to the target webpage in the preset icon library, if so, the flow goes to step S1250, and if not, the flow goes to step S1260.

The display apparatus can search the preset icon corresponding to the target webpage in the preset icon library, and if it is determined that there is a preset icon corresponding to the target webpage in the preset icon library, the icon information corresponding to the target webpage can be obtained in the preset icon library, so the step S1250 can be performed to search the preset icon corresponding to the target webpage in the preset icon library to obtain the icon information of the target webpage. If it is determined that there is no preset icon corresponding to the target webpage in the preset icon library, the icon information corresponding to the target webpage cannot be obtained in the preset icon library, so step S1260 can be performed to obtain the icon information of the target webpage through the target browser.

Step S1240: obtaining the homepage screenshot information of the target webpage and generating the icon information of the target webpage based on the homepage screenshot information.

The display apparatus can send the user's operation information from the webUI to the webengine through the message communication, and the webengine will start the webpage loading of the target webpage in the background according to the webpage address, take a screenshot of the homepage when the webpage is loaded, and obtain the homepage screenshot information of the target webpage as the icon information of the target webpage.

Step S1250: searching the preset icon corresponding to the target webpage in the preset icon library to obtain the icon information of the target webpage.

The preset icon library can store the icon information of multiple webpages, such as web logos, URLs, and webpage loading scripts, etc. According to the URL of the target webpage and other information, the icon information of the preset icon corresponding to the target webpage can be obtained from the preset icon library to obtain the icon information of the target webpage.

Step S1260: obtaining the icon information of the target webpage through the target browser. Here, the target browser can include the Odin browser.

The display apparatus can obtain the icon information of the target webpage through the Odin browser according to the method as shown in FIG. 23. For example, the display apparatus can send the user's operation information to the Odin browser through the webUI, and the Odin browser obtains the icon information of the target webpage based on the user's operation information, and sends the icon information of the target webpage to the webUI through the webengine.

Through the above-mentioned method, when the display apparatus is in the first loading mode, it can, in response to the favorite operation from the user for the target webpage, obtain the icon information of the target webpage according to the domain name type of the target webpage and the preset icon in the preset icon library, facilitate the user to determine the webpage content of the target webpage according to the icon information of the target webpage, and improve the speed of loading the target webpage.

In some embodiments, the icon information of the target webpage can be encoded according to base64 encoding rules and stored in a database. In the database, the file type of the icon information of the target webpage is a DB file.

Step S530: in response to a selection operation from the user for icon information for the target webpage, controlling the display to present the target webpage.

After obtaining the icon information of the target webpage, the display apparatus can receive a selection operation from the user for the icon information of the target webpage and control the display to switch the presented page to the target webpage. For example, the homepage of a browser application may have a plurality of recommendation positions, the icon information of the target webpage may be presented at a certain recommendation position. When the user selects the icon information of the target webpage, it indicates that the user wants to open the target webpage, and in this case, the display apparatus can use the icon information of the target webpage to obtain the information of opening the target webpage, enter the target webpage through this information, and present it on the display.

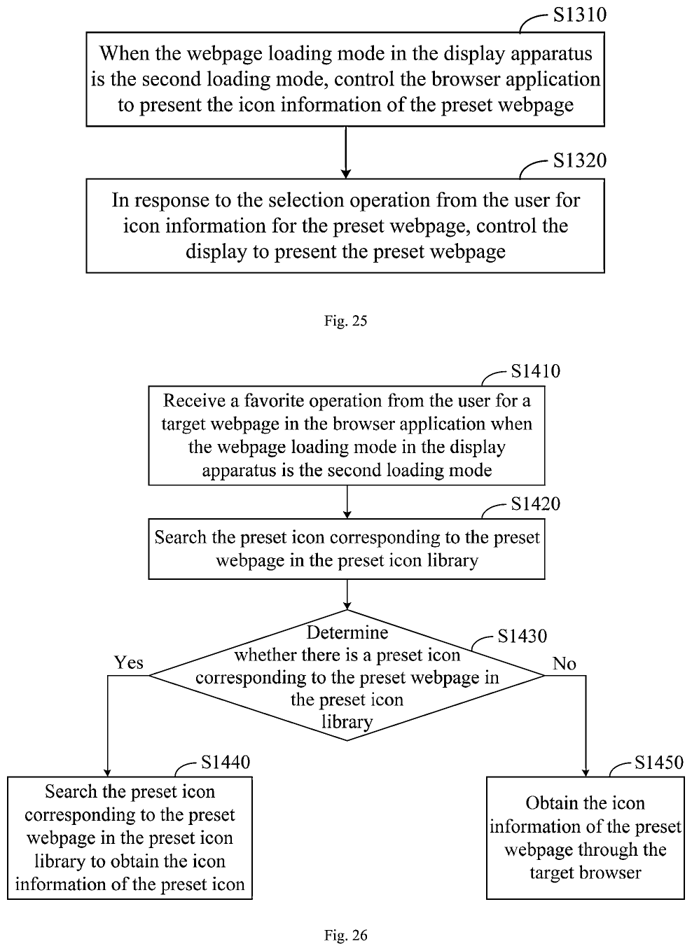

In some embodiments, the target webpage may include a preset webpage that is preconfigured in the display apparatus. Here, the preset webpage, e.g., a user webpage developed by an Internet manufacturer, or a webpage that may be commonly used by some users, such as a search webpage, a video webpage, a game webpage, etc., can be a webpage that can be accessed by users in the display apparatus in advance. To facilitate the user's access to the prebuilt webpage, the display apparatus can also perform the following methods, as shown in FIG. 25.

Step S1310: when the webpage loading mode in the display apparatus is the second loading mode, controlling the browser application to present the icon information of the preset webpage.

The icon information of the preset webpage can be pre-configured by the developer, and the icon information of the preset webpage can be presented in the recommendation bar of the homepage of the browser application. The recommendation bar can include a plurality of recommendation columns, and each recommendation column can correspond to icon information of one preset webpage, or it can also be presented in the favorite bar of the browser application, and the icon information of the preset webpage can be presented in the favorite bar when the user opens the favorite bar.

When the webpage loading mode in the display apparatus is the second loading mode, it means that the user wants the webpage to be loaded faster, or the current webpage loading performance of the display apparatus is better, and in order to facilitate the loading of the webpage content, the display apparatus can control the browser to present the icon information of the preset webpage so that the user can make a selection.

Step S1320: in response to a selection operation from the user for icon information for the preset webpage, controlling the display to present the preset webpage.

When receiving the selection operation from the user for the icon information of the preset webpage, it indicates that the user wants to open the preset webpage, and in this case, the display apparatus can load the preset webpage according to the icon information of the preset webpage, and control the display to present the preset webpage.

Because the preset webpage and its icon information are pre-configured in the display apparatus, when receiving the user's operation of loading the preset webpage, the display apparatus can quickly load and present the preset webpage according to the icon information of the preset webpage, and the loading speed of the webpage can be significantly improved compared with the way of obtaining the loading information of the webpage first.

In step S1310, in order to obtain the icon information of the preset webpage, in some embodiments, the display apparatus may also perform the following method.

Searching the preset icon corresponding to the preset webpage in the preset icon library to obtain the icon information of the preset webpage.

Because the preset icon library is icon information base pre-configured by the developer, and can include the loading information of multiple webpages, the icon information of the preset webpage can be quickly found by searching the preset icon corresponding to the preset webpage in the preset icon library.

Further, in some embodiments, the display apparatus may also perform the following methods.

If the preset icon corresponding to the preset webpage is not found in the preset icon library, the icon information of the preset webpage is obtained from the target browser. Here, the target browser can be the Odin browser.

If the display apparatus fails to find the preset icon corresponding to the preset webpage in the preset icon library, the display apparatus obtains the icon information of the preset webpage through the target browser in order to obtain the icon information of the preset webpage.

The display apparatus can send the user's operation information, that is, the operation information of obtaining the icon information of the preset webpage, to the Odin browser through the webUI, and the Odin browser obtains the icon information of the preset webpage based on the user's operation information, and sends the icon information of the preset webpage to the webUI through the webengine.

FIG. 26 is a flow chart of another display control method according to some embodiments of the present disclosure. As shown in FIG. 26, the method may include the following steps.

Step S1410: receiving a favorite operation from the user for a target webpage in the browser application when the webpage loading mode in the display apparatus is the second loading mode.

Step S1420: searching the preset icon corresponding to the preset webpage in the preset icon library.

Step S1430: determining whether there is a preset icon corresponding to the preset webpage in the preset icon library, if so, the flow goes to S1440, and if not, the flow goes to S1450.

Step S1440: searching the preset icon corresponding to the preset webpage in the preset icon library to obtain the icon information of the preset icon.

Step S1450: obtaining the icon information of the preset webpage through the target browser.

The display apparatus can obtain the icon information of the preset webpage through the Odin browser. For example, the display apparatus can send the user's operation information to the Odin browser through the webUI, and the Odin browser obtains the icon information of the preset webpage based on the user's operation information, and sends the icon information of the preset webpage to the webUI through the webengine.

When the browser application opens multiple webpages, it may cause the browser application's webpage to be loaded slower, therefore, in some embodiments, the display apparatus may also perform the following methods in order to improve the loading speed.

When the webpage loading mode in the display apparatus is the second loading mode, turning off other presented pages of the browser application, and the other presented pages include other presented pages in the browser application other than the currently presented page.

When the webpage loading mode in the display apparatus is the second loading mode, it means that the webpage loading speed of the display apparatus is faster, and in order to further improve the running speed of the display apparatus, the display apparatus can close other presented pages of the browser application, such as other pages other than the currently presented page. That is, the display apparatus can control the browser application to open and present only the page last operated by the user and close other pages.

In this way, the display apparatus can close the inactive pages in the browser application in a timely manner, so the problem of the browser application running slowly due to opening too many inactive pages is avoided, and the running speed of the browser application is improved.

In some embodiments, when closing other presented pages of the browser application, that other presented page may also be a page other than the N presented pages recently opened by the user, where N is a positive integer greater than 1. That is, when closing other presented pages of a browser application, the display apparatus may close other pages except for the N presented pages that the user has recently opened, depending on the opening order of the presented page.

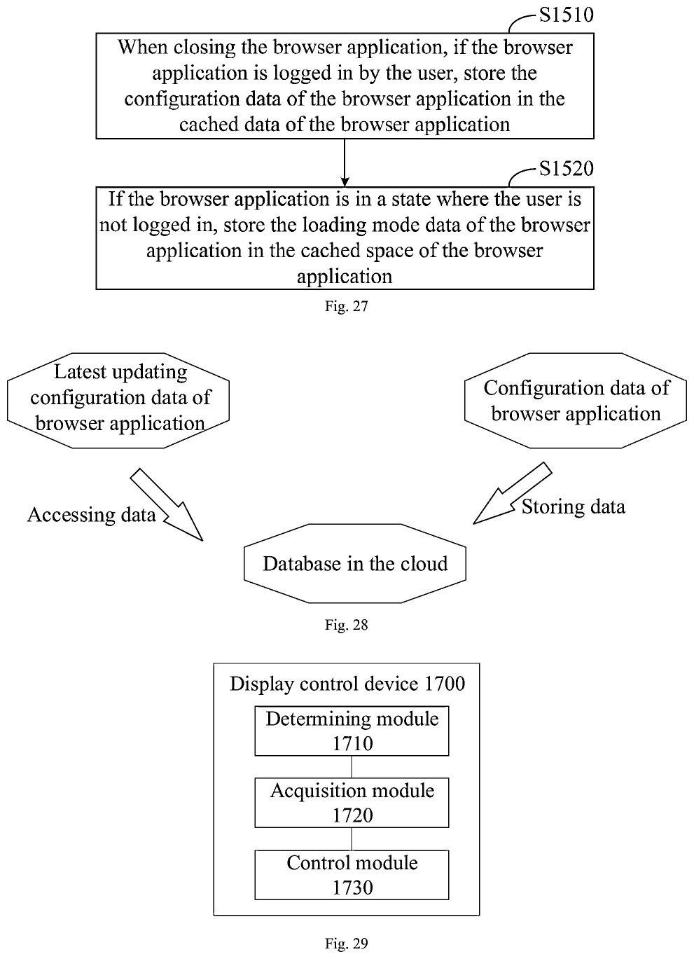

When the user has finished using the browser application, they can close the browser application. In order to save the settings made by the user when using a browser application, in some embodiments, the display apparatus may also perform either the following steps S1510 or the step S1520 with reference to FIG. 27.

Step S1510: when closing the browser application, if the browser application is logged in by the user, storing the configuration data of the browser application in the cached space of the browser application.

Here, the configuration data of the browser application may include all the configuration data related to the browser application, such as the webpage loading mode of the browser application, the user's favorite webpage(s), etc.

When a browser application is logged in by a user, the display apparatus can synchronously store the configuration data of the browser application in the cached space of the browser application in order to save the settings made by the user, such as favorite webpages, when the display apparatus receives the operation from the user to close the browser application. In this way, the next time a user logs in and uses the browser application, the latest configuration data is available to keep the browser application up to date.

Step S1520: if the browser application is in a state where the user is not logged in, storing the loading mode data of the browser application in the cached space of the browser application.

Here, the loading mode data of the browser application can be the data of the user setting when the webpage loading mode of the browser application is the first loading mode or the second loading mode.

When a browser application is in a state where the user is not logged in, the display apparatus may not need to save the user's settings for the browser application synchronously, at which point, the display apparatus may store only the browser application's loading mode data in the cached space of the browser application. In this way, the next time the user opens the browser application, the browser application's webpage loading mode retains the last setting, while the other settings are not saved.

In some embodiments, when the browser application is in a state where the user is not logged in, the display apparatus may also not save any settings made by the user on the browser application, that is, the loading mode data of the browser application is not stored.

In some embodiments, the display apparatus may store the configuration data of the browser application in the cached space of the browser application when the browser application is closed, regardless of whether the user is logged in or not logged in.

In this way, the next time the user uses the browser application, they will be able to use the latest setting of the browser application.

When the data volume of the configuration data of the browser application is large, storing the configuration data of the browser application locally causes a large amount of storage space to be occupied, and considering that the user may use multiple devices to log in to the browser application, in order to facilitate the synchronization of the configuration data of the browser application, in some embodiments, the configuration data of the browser application can be stored locally in the display apparatus or in a cloud database.

For example, as shown in FIG. 28, when a browser application is in the user login state, the display apparatus can upload the configuration data of the browser application to the cloud database through an HTTP interface; when the browser application is in a state where the user is not logged in, it can be left out of the upload. The next time the user logs in to the browser application, the display apparatus can obtain the configuration data of the most recently uploaded browser application from the cloud database.

according to the display control method described in the embodiments, the display apparatus can, in response to a favorite operation from the user for the target webpage in the browser application, determine the webpage loading mode in the display apparatus, obtain the icon information of the target webpage based on the webpage loading mode in the display apparatus, and in response to the selection operation from the user for the icon information of the target webpage, control the display to present the target webpage. When the user chooses to favorite the webpage, the display apparatus can obtain the icon information of the webpage, so that the user can control the display apparatus to quickly enter the target webpage through the icon information of the target webpage, and the display can present the target webpage, which can improve the speed of the display apparatus loading and presenting the webpage of the website, and improve the user experience.

Some embodiments of the present disclosure also provide a display control device, as shown in FIG. 29, the display control device 1700 may include: a determining module 1710 configured to, in response to the favorite operation from the user for the target webpage in the browser application, determine the webpage loading mode in the display apparatus; an acquisition module 1720 configured to obtain the icon information of the target webpage based on the webpage loading mode in the display apparatus; a control module 1730 configured to, in response to the selection operation from the user for the icon information of the target webpage, control the display to present the target webpage; wherein, the loading mode of the display apparatus includes a first loading mode and a second loading mode, the page load speed when the display apparatus is in the first loading mode is smaller than the page load speed when the display apparatus is in the second loading mode.

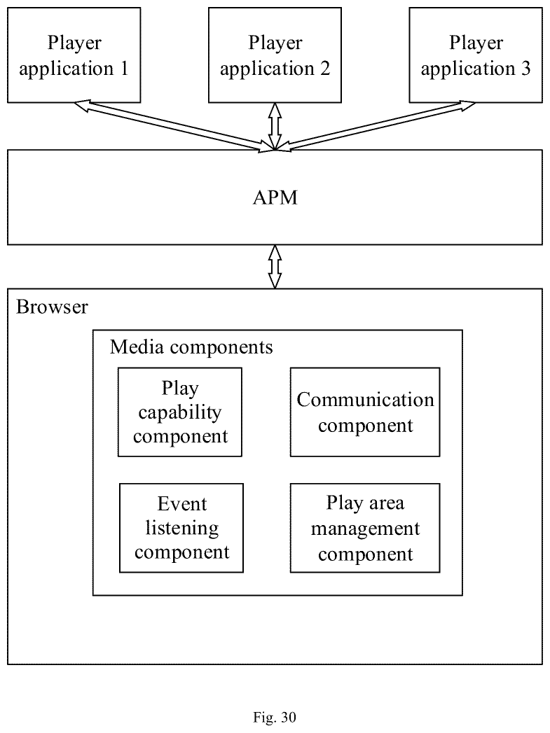

For the software aspect of the display apparatus, with reference to FIG. 30, a schematic diagram of a software architecture of a display apparatus according to the embodiments of the present disclosure. As shown in FIG. 30, as an example, the player application on the display apparatus includes a player application 1, a player application 2 and a player application 3. The three player applications can be respectively Hiplayer, mpctrl dmp and source, which can support the play of various types of media resources, and have the ability to execute play-pause control logic, identify the video state and progress and give feedback, and the ability to locate the play position.

In some embodiments, the browser is provided with a media component, and the media component is used to realize the function that the video image of the player application penetrates the browser interface. Media components can include play capability components, communication components, event listening components, and play area management components.

In some embodiments, the play capability component is configured to: after detecting a user command for playing a media resource, read the relevant information of the media resource, such as duration and bitrate, and send the relevant information of the media resource and a signal requesting to start play to the play area management component.

In some embodiments, the communication component is configured to: receive information about media resource and the signal requesting to start play sent from the play capability component, transmit the received data to the event listening component and the play area management component, listen to signals from the event listening component, such as user pause play, progress bars, etc., and then pass these signals to the play capability component and the play area management component.

In some embodiments, the event listening component is configured to listen to the user's operations, such as clicking to play, pause, fast-forward, rewind, and other events, and when these events are detected, send corresponding signals to the communication component.

In some embodiments, the play area management component is configured to: after receiving the relevant information of the media resource and the signal requesting to start play, establish a play area, and load the media file of the media resource in the play area, listen to the signal from the communication component, control the play state of the media resource according to the signal, update the progress bar, and perform other operations.

In some embodiments, in order to start the player application, APM is provided with an application startup interface, which is configured to initialize the player application.

In some embodiments, in order to realize communication with the browser, the APM is provided with the following interface: a play interface which is used for receiving the video play message from the browser; a pause interface which is used for receiving the pause play message of the browser; a stop interface which is used for receiving the stop play message of the browser; a video playable interface which is used for sending a video playable message to the browser; a play abnormal interface which is used for sending a message for indicating abnormal event to the browser; and a play completion interface which is used for sending a play completion message to the browser.

In some embodiments, the browser has the ability to dig holes, and can make the display area at the position of the play window transparent through rendering technology, so as to realize the effect of clearing the pixels of the area, so that the video image of the player application that is at the layer under the layer where the browser is located can penetrate through, and ensure that the video is played correctly, so as to provide users with a unified playback page and control.

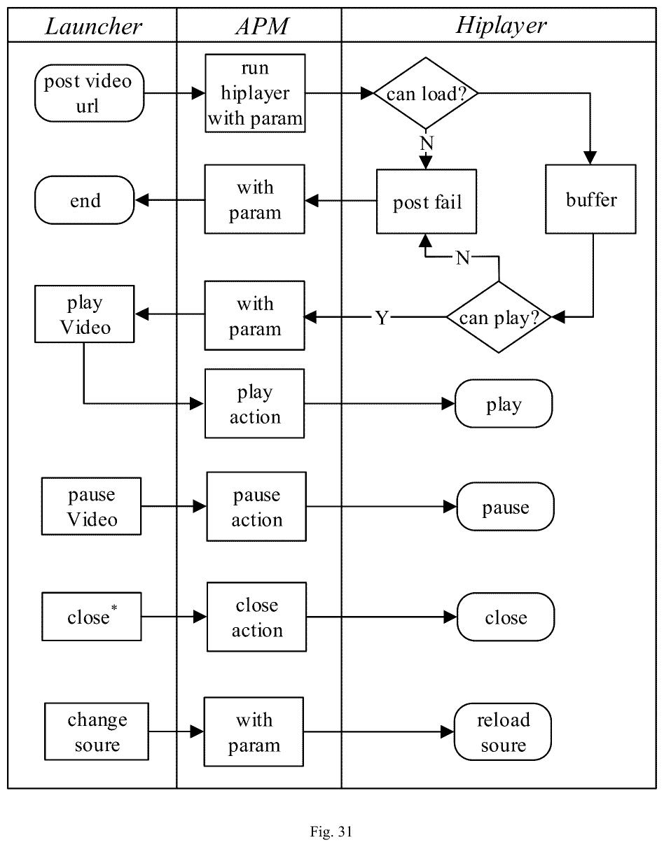

In some embodiments, taking the player application as the hiplayer and the browser as the Launcher as an example, the interaction among the APM, the player application and the browser can be shown in FIG. 31. As shown in FIG. 31, the commands sent from the browser to the APM may include sending a video URL (Uniform Resource Locator), playing a video, pausing a video, closing a video, and switching video sources.

Here, after the browser sends the video URL to the APM, the APM launches the player application.

After receiving the startup command, the player application determines whether the video corresponding to the media resource of the URL can be loaded, if it fails to be loaded, it returns a message of play failure to the APM, if it is able to be loaded, it loads the video, and then determines whether it can be played, if the video cannot be played, it returns a play failure message to the APM, and the APM returns the play failure message back to the browser, and the browser ends the video play process; and if the video can be played, it returns a message of successful play to the APM, and the APM passes the message of successful play to the browser. After receiving the message of successful play, the browser implements the video play process and sends a command to the APM to play the video, and the APM controls the player application to start video play based on the command.

After the browser sends a command to the APM to pause the video, the APM controls the player application to pause the video.

After the browser sends a command to the APM to close the video, the APM control the player application ends playing the video.

After the browser sends a command to the APM to switch the video source, the APM controls the player application to reload the new video source.

In some embodiments, the command received by the APM from the browser or the message fed back from the player application carries parameters, which may include message type, message source, message data, destination application ID and service tag. For example, in the parameters carried by the browser when sending a video URL to the APM, the message type is APM message, the message source is Launcher, the message data is the URL, the message event is the play command, the destination application ID corresponds to the hiplayer, and the service tag is the ID of the media resource.

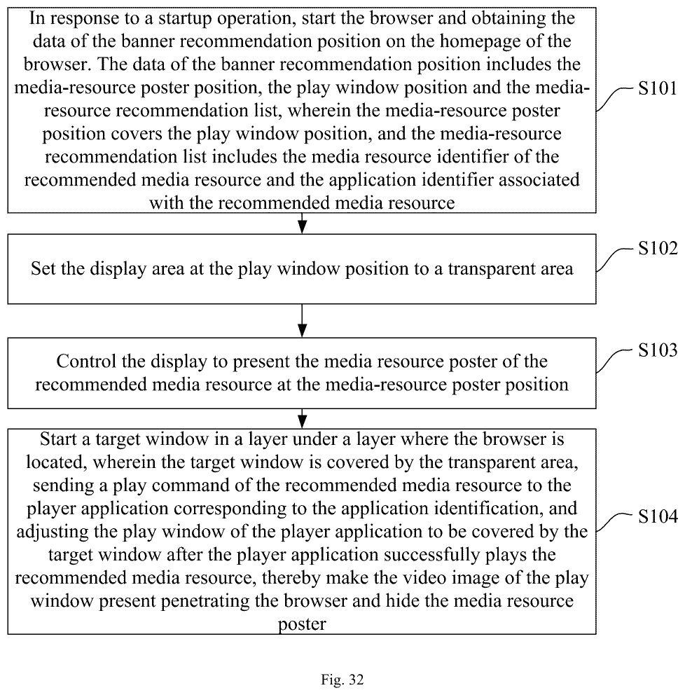

Based on the above-mentioned configuration of the browser and the APM, some embodiments of the present disclosure provide a browser-based video play method. As shown in FIG. 32, the method may include the following steps.

Step S101: in response to a startup operation, starting the browser and obtaining the data of the banner recommendation position on the homepage of the browser. The data of the banner recommendation position includes the media-resource poster position, the play window position and the media-resource recommendation list, wherein the media-resource poster position covers the play window position, and the media-resource recommendation list includes the media resource identifier of the recommended media resource and the application identifier associated with the recommended media resource.

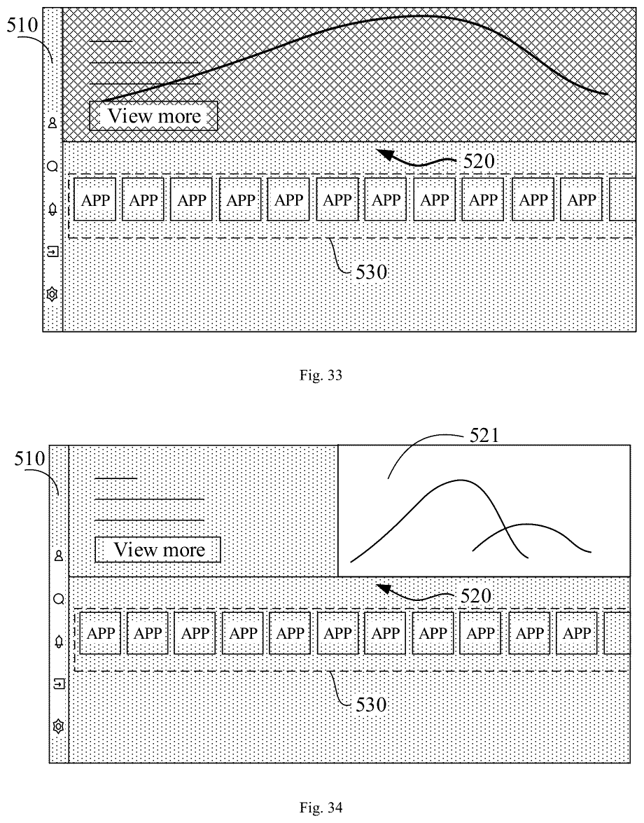

In some embodiments, after the user turns on the display apparatus, the display apparatus can start a browser and send a request for browser homepage to the server, so that the server can deliver the homepage data of the browser. The homepage data includes the data of the banner recommendation position, the display area of the banner recommendation position can be seen in FIG. 33. As shown in FIG. 33, the data of the banner recommendation position can be used to present the banner recommendation position 520, the media resource poster or the media resource video can be presented in the banner recommendation position 520. In FIG. 33, a media resource poster is shown in the banner recommendation position 520.

The homepage of the browser is also provided with a sidebar 510 and an application bar 530, wherein the sidebar 510 is used for presenting some control menu controls, and the application bar 530 is used for presenting a plurality of application controls, and the applications corresponding to these application controls are recommended applications or installed applications. The user can enter the application by clicking an application control in the application bar 530.

In some embodiments, the data of the banner recommendation position may include a media-resource poster position, a play window position and a media-resource recommendation list. The media-resource poster position can be the same as the banner recommendation position 520. The media-resource poster position can cover the play window position. The upper, lower and right edges of the play window position coincide with the upper, lower and right edges of the media-resource poster position respectively, and the left edge of the play window position is determined according to the size ratio of the play window, such as 16:9, so that the display area of the play window position is guaranteed.

The media-resources recommendation list may include a plurality of media resource data of recommended media resources. The media resource data includes media resource identifiers, media resource posters, media resource introduction information and application identifiers. The application identifier is the identifier of the application associated with the recommended media resources. The application is a player application. The recommended media resources in the media-resource recommendation list may come from the same player application or from different player applications, and the embodiments of the disclosure do not make specific restrictions on this. For example, if a recommended media resource has no media resource poster, for example, if the recommended media resource is a short video, the server can determine the first frame image of the recommended media resource as the media resource poster of the recommended media resource. If a recommended media resource has no media resource introduction information, the server can determine the default media resource introduction information as the media resource introduction information of the recommended media resource, such as “Welcome to watch”, or it cannot set the media resource introduction information.

In some embodiments, the data of the banner recommendation position does not include the play window position. The display apparatus can determine the media-resource poster position as the play window position.

In some embodiments, the data of the banner recommendation position does not include play window position. The display apparatus may determine a play window position in the coverage area of the media-resource poster position, where the display area of determined play window position is smaller than the corresponding area of the media-resource poster position.

For example, a maximum position with the same size ratio as the size ratio of the recommended media resource can be determined within the coverage area of the media-resource poster position as the play window position, where the size ratio of the recommended media resource can be included in the data of the banner recommendation position, or the size ratio of the media resource poster can be determined as the size ratio of the recommended media resource.

In some embodiments, compared with loading media resource posters, the time to load media resource video is relatively long, and it may have loading failure due to reasons such as slow network speed and network instability, therefore, the banner recommendation position 520 can be configured to present the media resource poster first, and then present the media resource video after the video stream data of the media resource video is ready.

Step S102: setting the display area at the play window position to a transparent area.

In some embodiments, the browser has a video play function. The browser is configured with a video layer. The video layer is used for generating a play window for playing the video. The browser in which the play function plug-in is removed still has the video layer. After obtaining the play window position from the data of the banner recommendation position, the display area at the play window position can be set to a transparent area in the video layer, for example, the display area can be set to transparent by rendering technology (such as OpenGL, DirectX, Vulkan, etc.), and the setting methods can include: creating a texture map with an alpha channel, and then applying the texture map to the display area at the play window position, enabling the blending function, and rendering by means of rendering techniques, such as OpenGL, to achieve transparent effect.

In some embodiments, the following techniques can also be used to set the transparent area. 1) HTML5 Canvas: the transparency of the drawn graph can be set by using the globalAlpha attribute provided by the Canvas API, so as to achieve transparent effect. 2) CSS: the opacity property of CSS is used to set the transparency of the element, so as to achieve the transparency effect. 3) DirectX: similar to the OpenGL, the DirectX can also use blending features and texture maps to achieve the transparency effect. 4) Vulkan: as a new generation of low-level graphics API, Vulkan also supports blending functions and texture map to achieve the effect of transparent areas.

Step S103: controlling the display to present the media resource poster of the recommended media resource at the media-resource poster position.

In some embodiments, after obtaining a media resource recommendation list from the data of the banner recommendation position, the media resource poster of the first media resource in the media resource recommendation list can be obtained, and the media resource poster is presented at the media resource poster position.

In some embodiments, in order to enable the user to better understand the recommended media resource, the display apparatus may arrange a floating layer above the media resource poster, as shown in FIG. 33, and the floating layer can be used to present the media-resource introduction information and the View-more control. After the display apparatus enters the homepage of the browser, the default focus is located on the banner recommendation position 520. When the user enters the confirmation command by pressing the “OK key” on the remote control, the display apparatus can send a full-screen play command to the player application corresponding to video of the media-resource introduction information, and the player application is switched to the foreground, so that the player application plays the media resource corresponding to the media-resource poster in full screen at the top layer of the display apparatus.

Step S104: starting a target window in a layer under a layer where the browser is located, wherein the target window is covered by the transparent area, sending a play command of the recommended media resource to the player application corresponding to the application identification, and adjusting the play window of the player application to be covered by the target window after the player application successfully plays the recommended media resource, thereby make the video image of the play window present penetrating the browser and hide the media resource poster.

In some embodiments, the layer under the browser's video layer is an underlying layer of the browser. In order to ensure that the video image of the player application can penetrate the browser for presenting, the display apparatus initiates a target window in a layer under the layer where the transparent area is located. The target window has no video play function and is only used for revealing the display content under the browser's video layer.

After the player application obtains the video stream data, it hides the media resource poster and uses a JavaScript script to adjust the play window of the player application to the layer under a layer where the target window is located, so that the video image of the recommended media file penetrates the transparent area. Since the target window is located under the transparent area, only a portion of the player application that is obscured by the transparent area will be revealed, creating a “hole-in” effect. Referring to FIG. 34, a schematic diagram of video play according to some embodiments. As shown in FIG. 34, the video image at the play window position 521 penetrates the transparent area and can be seen by the user.

In some embodiments, after obtaining a recommendation list of media resources from the data of the banner recommendation position, the application identifier of the first media resource in the recommendation list of media resources can be obtained. The display apparatus can determine whether the player application identified by the application identifier is started, and if the player application is started, it sends a play command of the first media resource to the player application, so that the player application obtains and plays the video stream data of the first media resource from the server; and if the player application is not started, the display apparatus can send a startup command to the player application, and then send a play command to the player application after the player application is started.

In some embodiments, when the display apparatus hides the media resource poster, it does not hide the media-resource introduction information.

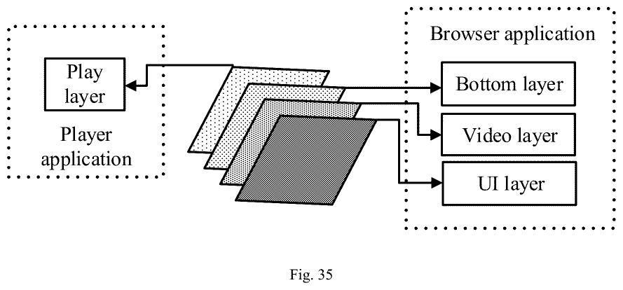

In some embodiments, according to the browser-based video play method described in the embodiments of the present disclosure, a layer distribution of the display apparatus may illustrate in FIG. 35. As shown in FIG. 35, the layer of the display apparatus is the UI layer, the VIDEO layer, the bottom layer and the play layer of the player application from the outside to the inside. The UI layer is used for presenting UI controls, media-resource poster sidebars, application bars and other interface elements. The VIDEO layer was originally used for presenting the play window of the browser, in the embodiments of the present disclosure, the VIDEO layer does not present the play window, the VIDEO layer can be set to a transparent area. The bottom layer is the outer shell layer of the browser, and can be used for establishing a new blank target window. The layer of the player application includes the play window created by the player application after the play application starts to play. The play window is used to load the video stream data of the recommended media resources.

The application sets the VIDEO layer to a transparent area, and after starting a target window at the bottom layer, the “hole-in” effect of the layer corresponding to the browser can be realized. Because when the video is played in the player application, the media resource poster of the UI layer is hidden, therefore, the video image located in the play layer can be presented through the browser and seen by the user.

In some embodiments, the UI layer is also used for presenting a media resource switching control. The media resource switching control may include a left switching control and a right switching control, which are respectively located on the left and right sides within the banner recommendation position 520. When the user issues the media resource switching control, the display apparatus closes the current player application, presents the media resource poster of the next recommended media resource, and sends the play command of the next recommended media resource to the player application corresponding to the next recommended media resource, so that the next recommended media resource is played in the play window position 521.

In some embodiments, the UI layer does not present the media resource switching control, but when the focus of the display apparatus is at the banner recommendation position 520, the user can still press the directional left button or the directional right button on the remote control to switch the recommended media resource.

In some embodiments, the first time that the player application plays the recommended media resource, such as 20 seconds or after the play ends, the display is controlled to present the media resource poster of the next recommended media resource, the play command of the next recommended media resource is sent to the player application corresponding to the next recommended media resource, the media resource poster of the next media resource is hidden after the next recommended media resource is successfully loaded, so as to make the video image of the next media resource penetrate the browser and display.

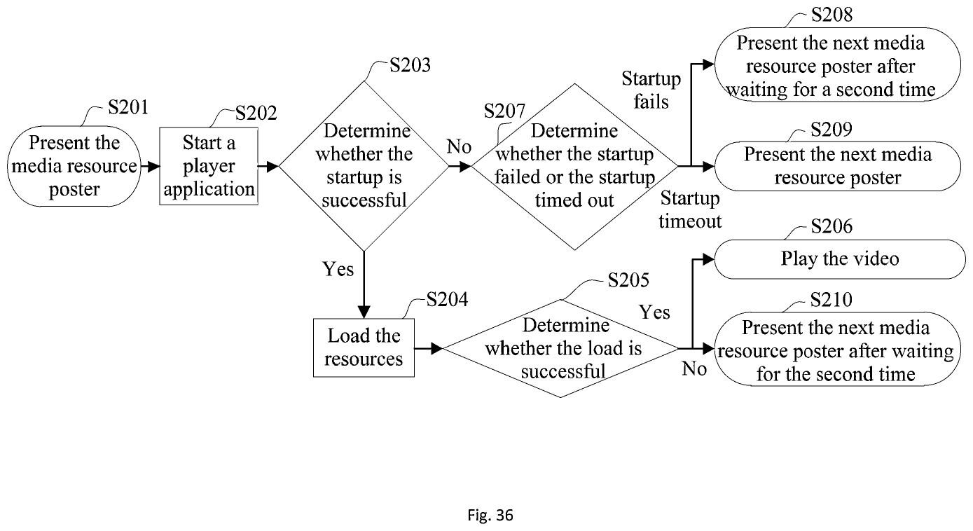

In some embodiments, the video play fails because the above-mentioned player application may not be installed on the display apparatus or the network is unstable. Some embodiments of the present application provide a play error handling method for the situation that the play failure, with reference to FIG. 36, and the method may include the following steps.

Step S201: presenting a media resource poster.

In some embodiments, after the display apparatus is turned on, it starts the browser, sends a browser homepage request to the server, and presents a media resource poster that recommends the media resource after receiving a recommendation list of media resources.

Step S202: starting a player application.

In some embodiments, after presenting a media resource poster of a recommended media resource, the display apparatus searches for the player application in the list of installed applications in the display apparatus according to an application identifier of the player application corresponding to the recommended media resource, and if the player application can be found, the display apparatus sends a startup command to the player application to start the player application.

Step S203: determining whether the startup is successful.

In some embodiments, the player application can return a message of successful startup after successful startup, and if it fails to start, it returns a message of failure to start. Based on the message that the player application is successfully launched, the player application can be determined to have started successfully.

Step S204: if the startup is successful, loading the resources.

In some embodiments, if the player application is successfully started, the player application can be controlled to load the video stream data of the recommended media resources, and then the play window of the video stream data is adjusted to the corresponding position of the target window.

Step S205: determining whether the load is successful.

In some embodiments, after the player application is successfully started, it can be determined whether the video stream data is successfully loaded. Here, the reasons for loading failure can include the failure of the player application to load video stream data due to network instability and other reasons.

Step S206: if the load is successful, playing the video.

In some embodiments, if the resource is successfully loaded, the video can be played to penetrate through.

Step S207: determining whether the startup failed or the startup timed out.

In some embodiments, if the player application corresponding to the media resource poster is not found, it can be determined that the player application fails to start. If a message received from the player application shows that the player application failed to start, it is determined that the player application fails to start.

In some embodiments, if a startup command is sent to the player application, and the message of the player application feedback is not received after the timeout period is reached, the player application startup timeout can be determined.

Step S208: if the startup fails, presenting the next media resource poster after waiting for a second time.

In some embodiments, if the player application fails to start, the media resource poster of the current recommended media resource can be presented for a second time, such as 20 seconds or 10 seconds later, and the media resource poster of a next recommended media resource can be switched.

Step S209: if the startup timeout, presenting the next media resource poster.

In some embodiments, if the player application startup times out, the current media resource poster can be presented for the second time, and then switched to the media resource poster that presents the next recommended media resource.

Step S210: if the loading fails, presenting the next media resource poster after waiting for the second time.

In some embodiments, if the loading of resources fails, the current media resource poster can be switched to present the next media resource poster after the second time of presentation.

As shown in FIG. 36, after a video of a recommended media resource fails to be played, the media resource poster of the recommended media resource can be presented for a period of time and then switched to the media resource poster of the next recommended media resource, so that the recommended media resource that fails to play the video can still achieve a certain recommendation effect through the media resource poster. Through the determination of timeout, application start, and resource loading, it can ensure the rotation recommendation of multiple recommended media resources and avoid getting stuck in one recommended media resource.

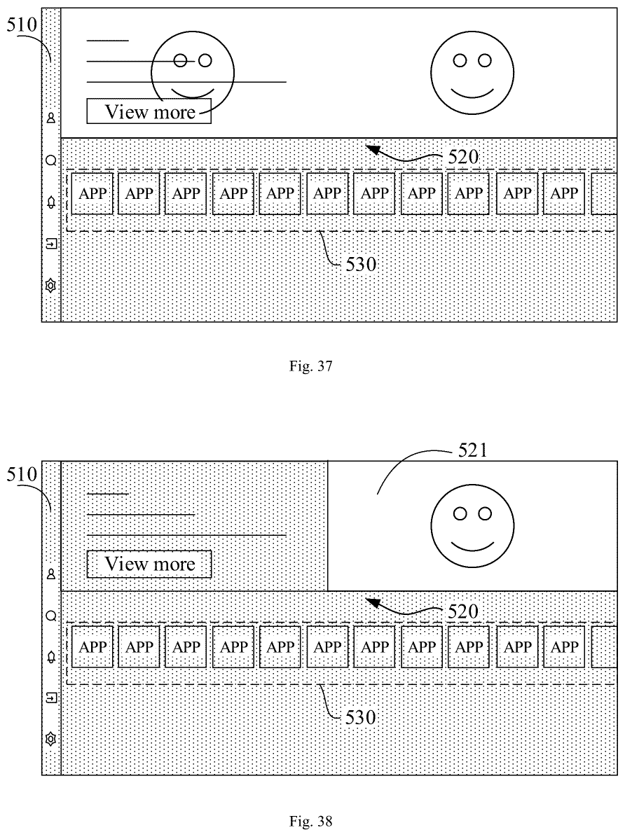

In some embodiments, after the video of the first media resource is finished, or after the video of the first media resource is played for the preset time, such as 20 seconds, the display apparatus can close the player application corresponding to the first media resource according to the recommendation list of media resources, present the media resource poster of the second media resource at the media resource poster position, as shown in FIG. 37, start the player application corresponding to the second media resource, hide the media resource poster of the second media resource after the player application corresponding to the second media resource is started, and restart a target window in the transparent area to present the video stream of the second media resource. As shown in FIG. 38, the target window corresponding to the second media resource and the target window corresponding to the first media resource can be the same, and so on.

In some embodiments, after the video of the last recommended media resource in the media resource recommendation list is played, the media resource recommendation can be performed in a loop starting from the first recommended media resource.

In some embodiments, in order to avoid frequently starting the player application and causing the display apparatus to be stuck, when the play of one of the media resources is completed, the player application may not be closed temporarily. Determining whether the application identifier corresponding to the next recommended media resource is the application identifier of the player application, and whether a video is set, wherein if a play address is set in the media resource data, it is determined that there is a video, and if a play address is not set in the media resource data, it is determined that the video is not set.

If the application identifier corresponding to the next recommended media resource is the application identifier of the player application, and a video is set, sending the play instruction of the next recommended media resource to the player application, and starting a countdown. Before the countdown ends, if the next recommended media resource is successfully played, the media resource poster of the next recommended media resource is hidden, and the countdown is cleared, so that the video image of the next media resource is presented through the browser, and at the end of the countdown, if the next recommended media resource is not successfully played, the countdown is cleared.

If the application identifier corresponding to the next recommended media resource is not the application identifier of the player application, or no video is set, closing the player application and starting the player application associated with the next recommended media resource.

If the adjacent recommended media resources associated with the same player application are included in the recommended media resource list, the start-stop frequency of the player application can be reduced, and the resource overhead of the display apparatus can be reduced through the above determination.

In some embodiments, after the display apparatus obtains a recommendation list of media resources, it determines whether the recommended media resources associated with the same application are included in the recommendation list of media resources, and if there are recommended media resources associated with the same application, it can determine whether the recommended media resources associated with the same application are adjacent in the recommendation list of media resources, and if not, the recommended media resources associated with the same application are adjusted to be adjacent in the recommendation list of media resources, and if they are adjacent, the order of the recommended media resources in the recommendation list of media resources is not adjusted. Through the above sorting, it further reduces the start-stop frequency of the player application, and reduces the resource overhead of the display apparatus when the player application starts and closes.

In some embodiments, after the display apparatus enters the homepage of the browser, the default focus is located on the banner recommendation position 520, and the user can move the focus of the display apparatus leftward to the sidebar 510.

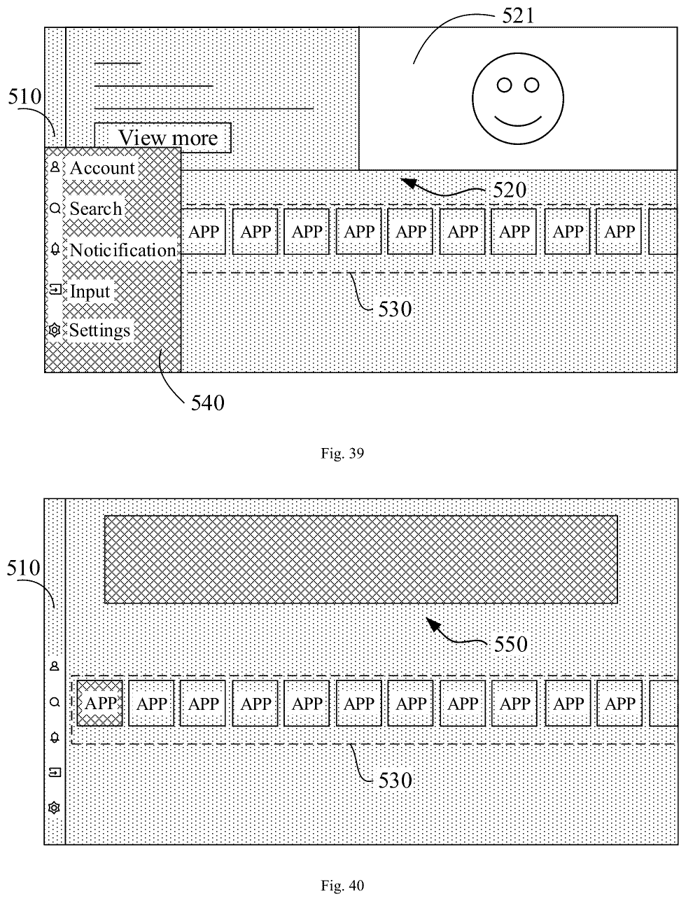

In some embodiments, as shown in FIG. 39, after the user moves the focus of the display apparatus from the display area of the banner recommendation position 520 to the sidebar 510, the display apparatus generates a sidebar floating layer 540 and continues to play the video in the play window position 521. The sidebar floating layer 540 is overlaid on top of the media resource poster or video image, making it easy for users to operate the controls in the sidebar.

In some embodiments, when the user moves the focus of the display apparatus out of the sidebar floating layer 540, the display apparatus hides the sidebar floating layer 540 and continues to play the video in the play window position 521.

In some embodiments, referring to FIG. 40, when the user moves the focus of the display apparatus to an application control in the application bar 530, the display apparatus can present an application detail description 550 corresponding to the application control, and the application detail description 550 is used for presenting the application detail information. The application detail description 550 can be located above the application bar 530 and can overlap or partially overlap with the position of the banner recommendation position 520. The display apparatus can send a pause play command to the player application, so that the player application pauses the play, and hides the display content of the banner recommendation position 520, so that the application detail description 550 can be seen by the user.

In some embodiments, when the user moves the focus of the display apparatus up once from the application bar 530, the focus is located on the application detail description 550, the user enters a confirmation command to enter the application corresponding to the application detail description 550, and after the user moves the focus up once again, the display apparatus can send a resume play command to the player application to make the player application continue playing, hide the application detail description 550, and present the content of the banner recommendation position 520.

It can be seen from the above embodiments that the display apparatus interacts with the player application by controlling the browser, presents the player application in the layer under the layer where the browser is located, and sets a part of the display area of the browser to a transparent area, which can make the player application penetrate to be presented on the page of the browser, enable the browser to achieve the effect of playing video without the play function plug-in, reduce the resource occupation and loading time of the browser, simplify the video play process, improves the fluency of the display apparatus, do not need to develop and maintain the play function plug-in of the browser, reduce the development and maintenance cost of the browser, realize transparent play through the browser, provide unified play page and control to users, and provide a size fixed window at a fixed position of the browser page to play video for users. The browser and the player application belong to different processes, and the sandbox isolation is realized, that is, application-level isolation, and the player application can be killed in the exit scenario of play, which will not affect the browser, and the memory can be reclaimed more accurately and quickly, and the overall performance can be optimized. Through presenting the media resource poster of recommended media resource before playing video, a caching time can be retained for video play, thereby avoiding video play lag and improving smoothness. Further, through the transparency technology and video penetration function, users can use other player applications or even other non-player applications in the internal container on the browser at the same time, without having to switch windows to skip to webpages or use multiple devices, which is convenient and fast, and improves the user's experience. By making it partially transparent on the browser, users can also choose other player applications based on their needs and place them in the transparent section to better customize their experience.

In some embodiments, in addition to native applications, such as browser applications, third-party applications are integrated on the display apparatus 200 to provide users with richer functions and resources through third-party applications.

A browser application of the display apparatus 200 can provide users with an entry to search on the Internet. The browser application is configured with a favorite function, which allows users to favorite the page if they see content of interest when browsing the page through the browser application. When a user wants to browse the page again, he/she can quickly enter the page based on the favorites in the browser application's favorites. The browser application is also configured with a bookmark function, which allows the user to bookmark a page if he/she sees something of interest when browsing through the browser application. When the user wants to go back to the page, he/she can quickly enter the page based on the bookmarks in the bookmark page of the browser application.

However, based on the collection function or bookmark function provided by the browser application, only the browser page can be stored locally in the display apparatus, and the entire page can be stored, and cannot be shared with other users.

In view of the above issue, the browser application of the display apparatus 200 according to the embodiments of the present disclosure is configured with sharing function of the browser page, so that after the page sharing function is enabled, the user can share the content to be shared with the selected page content to other users by selecting the page content of the browser page.

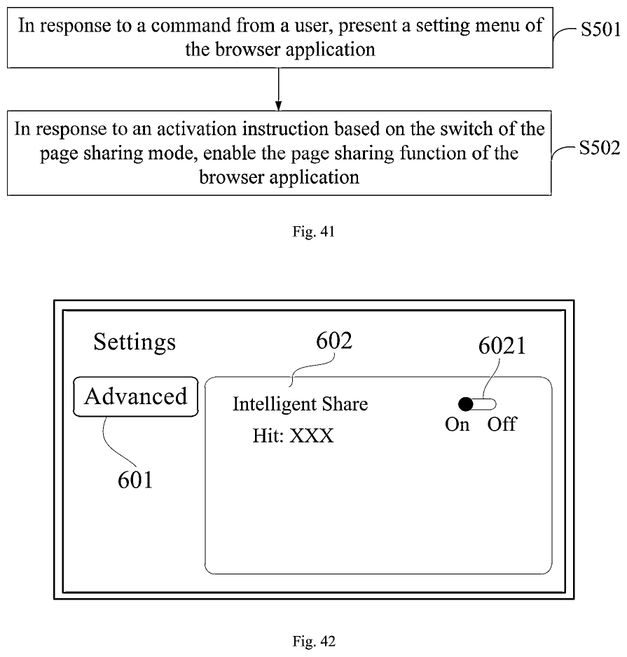

The display apparatus 200 can enable the page sharing function of the browser application according to the process shown in FIG. 41, and the specific steps are as follows.

S501, in response to a command from a user, presenting a setting menu of the browser application.

The setting menu of the browser application includes a switch of the page sharing function, which is used to turn on and off the page sharing function of the browser application, wherein when the switch of the page sharing function is turned off, the page sharing function is turned off. When the page sharing function is turned on, the page sharing function is enabled. In some embodiments, the browser application turns off the page sharing function by default.

The browser application can be configured with an entrance of the setting menu in the main page, and the user can input commands based on the entrance to instruct the display apparatus 200 to present the setting menu of the browser application. The setting menu of the browser application can be referred to FIG. 42, which includes an advanced option 601, and the menu page 602 corresponding to the advanced option 601 includes a switch 6021 for the page sharing mode. The menu page 602 may also include a prompt message for switch 6021, such as the name “Intelligence Share” corresponding to switch 6021 of the page sharing mode, and the description of the page sharing mode “hit:xxx”, etc.

S502, in response to an activation instruction based on the switch of the page sharing mode, enabling the page sharing function of the browser application.

The display apparatus 200, in response to the activation instruction for activating the page sharing mode from the user, adjusts the switch 6021 of the page sharing function to the enable state as shown in FIG. 42.

In order to make it easier for users to use the page sharing function directly next time they use the browser application, the enable state of the page sharing function of the browser application this time can be recorded, so that the next time they use the browser application, the recorded enable state will be used by default.

In some embodiments, if the user is not logged in to the user account, the display apparatus 200 can record the browser application in the local storage as enabling the page sharing function. The page sharing function can be stored in the following data structure:

setBrowserShare (state, newValue) {
state.LocaltionData.browserShareStatus;=newValue
}.

Here, browserShareStatus indicates the state of the page sharing function by representation of newVaule which can be Boolean. For example, True indicates that the page sharing function is enabled, and False indicates that the page sharing function is disabled. The state.LocaltionData is all configuration data configured in the setting page of the browser application, such as setting the homepage, advertising switches, version information, history information, etc.

When the browser application exits for destruction, the content of state.LocaltionData is stored in the browser's local storage, for example, in the following data storage structure:
window.localStorage.setItem (‘LocationData’,JSON.stringify (this.LocaltionData)).

When the user uses the browser application of the display apparatus 200 next time, the display apparatus 200 will directly enable the page sharing function based on the page sharing function recorded in the local storage.

In some embodiments, if a user account has been logged in, the display apparatus 200 can record the browser application as enabling the page sharing function in local storage and in the cloud corresponding to the user account.

The display apparatus 200 records the browser application as the data structure and data storage structure of the page sharing function when the corresponding user account is stored locally by referring to the data structure and data storage structure of the page sharing function are stored locally when the user account is not logged in, and the difference is that the relevant fields of the user account need to be added to the data storage structure, and the following data storage structure can be used:
window.localStorage.setItem(‘LocationData_${userID}’,JSON.stringify(this.LocaltionData)).

The display apparatus 200 can upload the enable state of the page sharing function to the cloud through the HTTP interface and store it under the user account.

When the user logs in to the user account on the display apparatus 200 and uses the browser application again, the display apparatus 200 first obtains the enable state of the page sharing function stored under the user account from the cloud, and directly enables the page sharing function by default. If the state record of the page sharing function from the cloud is not obtained, the enable state of the page sharing function corresponding to the record of the user account from the local storage can be obtained, and directly enable the page sharing function by default. When a user logs in to a user account on another display apparatus, if a browser application is used, the display apparatus can obtain the enable state of the page sharing function stored under the user account from the cloud, and directly enable the page sharing function by default, so as to realize the user's personalized settings for using the browser application on different display apparatuses.

After enabling the page sharing function of the browser application, the user can share the page content of the browser page with other users.

Combined with the following embodiments, the method of how to share the page content when the browser page is presented is described after the display apparatus 200 turns on the page sharing function of the browser application.

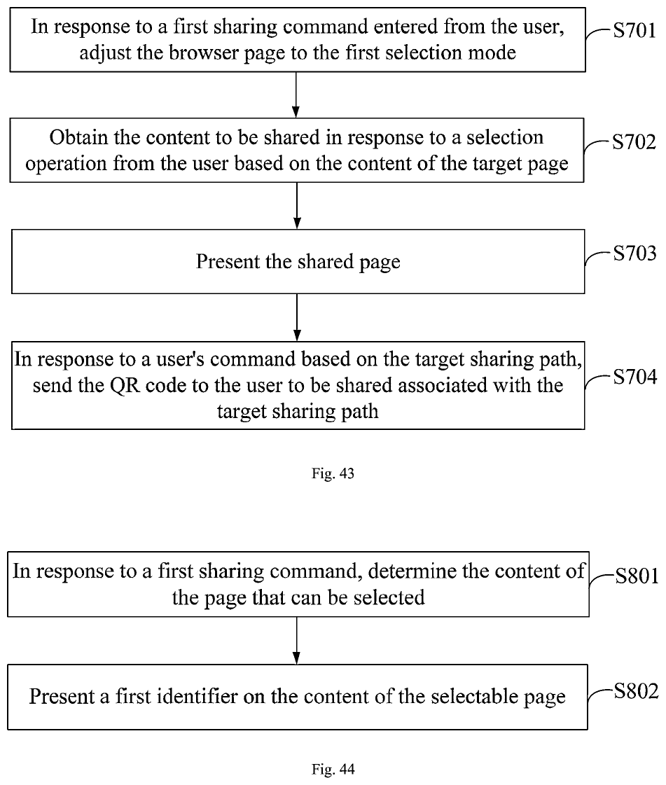

In a first example, the display apparatus 200 can share the page content of the browser page according to the process shown in FIG. 43, and the specific steps are discussed below.

S701, in response to a first sharing command from the user, adjusting the browser page to the first selection mode.

The user can input a first sharing command to the display apparatus 200 based on the first combination key on the control device 100. Take the control device 100 as the remote control as an example, the first combination key can be a numeric key combination, blue, green, red, yellow key combination, etc.

The display apparatus 200 first determines whether the browser page is a non-shareable page before adjusting the browser page to the selection mode in response to the first sharing command. Pages that cannot be shared include the pages of the browser itself, such as the browser homepage, the browser setting page, etc., as well as the browser pages whose links are in a blacklist.

Since the page of the browser itself involves the self-developed results of the platform and is not suitable for sharing at will, in order to protect the interests of the platform, the page of the browser itself can be set as a page that cannot be shared. If the display apparatus 200 recognizes that the browser page is the page of the browser itself, the display apparatus 200 does not turn on the page sharing mode, that is, the browser page is maintained in the non-selected mode.

In order to ensure the security of the shared content, the display apparatus 200 can store the blacklist in advance, and the links in the blacklist are non-shareable links, and these non-shareable links include specified fields, for example, the links including the “%%%%” field are non-shareable links. If the display apparatus 200 recognizes that the link of the browser page belongs to the blacklist, the page sharing mode is not turned on, that is, the browser page is kept in the non-selected mode.

If the browser page is not the browser itself, and the link of the browser page does not belong to the blacklist, the page sharing mode is enabled, that is, the browser page is adjusted to the first selection mode.

The first selection mode is an intelligent selection mode, that is, the page content that can be selected is automatically recognized by the display apparatus 200. When the browser page is in the first selection mode, the page content with the uniform resource locator (URL) link in the browser page is the page content that can be selected. The URL link of the page content can be the URL link used to obtain the page content, for example, if the page content is an image, a URL link of the image can be the storage address of the image in the network and used to obtain the image from the network. The URL link of the page content can also be a URL link to get the webpage associated with the page content, such as the page content is an option with an associated webpage, and the URL link of the option is a webpage link to the webpage that is used to get the webpage.

The display apparatus 200 can adjust the browser page to the first selection mode according to the process shown in FIG. 44, and the specific steps are as follows.

S801, in response to a first sharing command, determining the page content that can be selected.

The display apparatus 200 can determine the page content that can be selected according to the document object model (DOM) information of the page content. The display apparatus 200, in response to the first sharing command, intelligently determines the DOM information of the page content on the browser page. DOM information can include a DOM link to the page content and the coordinates of the page content.

Here, the DOM link to the page content can include a URL link, which is denoted as an empty string if no DOM link exists.

The coordinates of the page content can be represented as two-dimensional coordinates, and the coordinates of the page content can be set to the coordinates within the current viewable area, which can be the coordinates of the specified points in the area where the page content is located, such as the coordinates of the center point and the coordinates of the lower left corner of the area. For example, if the page content is an image and the center point of the area is a specific point, the area where the page content is located is a corresponding display area of the image in the current viewable area, and the coordinates of the center point of the display area in the current viewable or visible area are the coordinates of the image.

DOM links based on the page content can determine page content that can be selected. If the DOM link of the page content is not empty, that is, the page content has a DOM link, the page content is the page content that can be selected. If the DOM link of the page content is empty, that is, the page content has no DOM link, then the page content is not selectable.

DOM information can also include the DOM type of the page content.

The DOM type of the page content, which can be represented by the tag type. Taking HTML tags as an example, tag types can include: formatting tags (such as title tags, paragraph tags, newline tags, etc.), text tags (such as font tags, italic tags, bold tags, etc.), hyperlink tags (such as normal links, empty links, email links, etc.), image tags, list tags (such as ordered lists, unordered lists, custom lists), table lists (such as tag lists, attribute lists, etc.), form tags (such as single-line text boxes, password text boxes, radio boxes, drop-down menus, file uploads, buttons, etc.).

Based on the DOM type of the page content, the content to be shared associated with the page content can be determined. For example, if the DOM type of the page content is an image, the content to be shared is the page content itself, that is, the image. If the DOM type of the page content is Form Label, such as a button, the content to be shared is the webpage corresponding to the DOM link of the page content.

S802, presenting a first identifier on the content of the selectable page.

The first identifier is used to indicate the page content that can be selected.

The display apparatus 200 presents a corresponding first identifier based on the coordinates of the page content that can be selected. The coordinates of the center point of the first identifier on the current viewport can be the coordinates of the page content that can be selected.

The style of the first identifier can be in regular geometry, and the first identifier can also be highlighted for easy user identification. The first identifier may also include a corner mark, which can be a number, text, etc., and is used for uniquely marking the first identifier so that the user can make a selection.

The display apparatus 200 uses focus management to add focus control and focus selection functions to the first identifier. The focus control can control the focus be presented on the first identifier, and move the focus on each first identifier. The focus selection function allows to select the content of the page content indicated by the first identifier based on the first identifier where the focus is located.

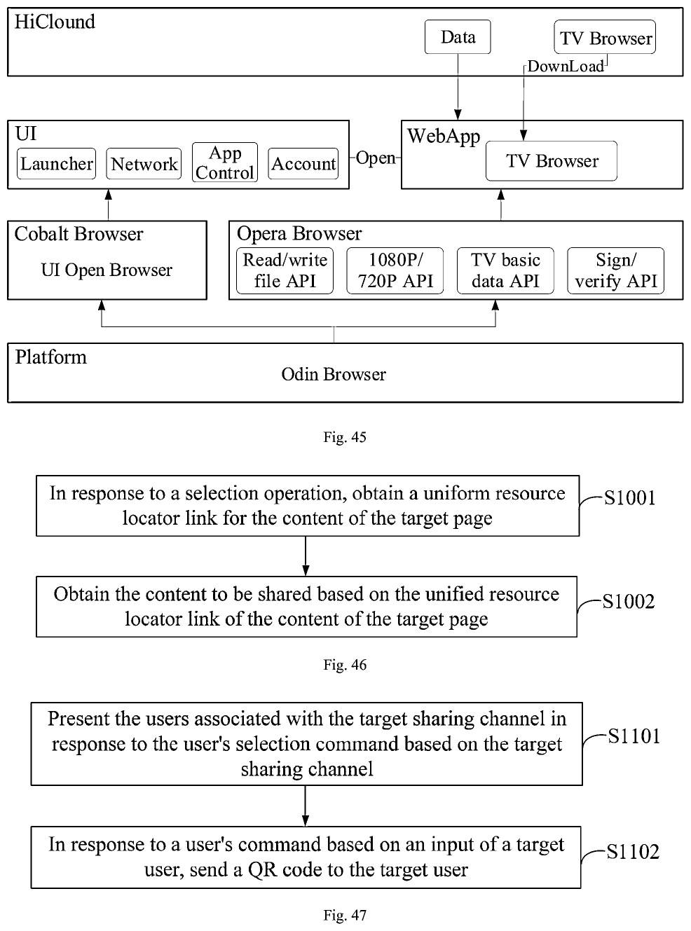

The display apparatus 200 can be implemented based on the system architecture shown in FIG. 45 to adjust the browser page to the first sharing mode. The system architecture includes an application layer, a hardware layer, and a platform layer. The application layer includes the UI of the browser application and the browser application (such as TV Browser), and the UI of the browser application includes the system desktop (Launcher), network, application control (App Control), account, etc. The browser application is connected with the cloud server to realize data transmission between the browser application and the cloud server. The hardware layer includes Cobalt Browser and Opera Browser, which are used to provide various interfaces to support the web engine, such as read/write file API, resolution interface (1080P/720P API), TV basic data API, and Sign/verify API. The platform layer includes browser kernels, such as the Odin browser.

The display apparatus 200, in response to a first sharing command, adjusts the browser page to the first sharing mode based on the system architecture shown in FIG. 45. The display apparatus 200 informs the web engine in the hardware layer of the method of calling the Odin browser through the long link in the UI in the browser application, to obtain the DOM information of the page content through the Odin browser, and returns the DOM information to the UI of the browser application by the web engine through the long link through the Odin browser. The UI of the browser application presents the first identifier on the content of the selectable page based on the obtained DOM information. Here, the DOM information can be transmitted in the following data structure.

### ShareObjectArray:

```
  [
  {ID: ‘××××××××’, //an identifier of communication process
  url: ‘https:// ××.com’, //a link of obtained page content
  X: ‘x’, //a horizontal coordinate in coordinates of page content
  Y: ‘y’, //a vertical coordinate in coordinates of page content
  htmlType: ‘××’, //obtained type of page content (tag type)
currentTime: ××-××-××, //time when the DOM information is obtained
  }
    ]
```

S702, obtaining the content to be shared in response to a selection operation from the user based on the content of the target page.

The content to be shared is the content associated with the DOM link of the content of target page.

The display apparatus 200 can obtain content to be shared according to the process shown in FIG. 46, and the specific steps are discussed below.

S1001, in response to a selection operation, obtaining a uniform resource locator link for the content of the target page.

The user can input a move command to the display apparatus 200 through the control device 100 to instruct the display apparatus 200 to present the focus on the first identifier corresponding to the content of the target page. The display apparatus 200, in response to a selection operation, recognizes the first identifier where the focus is located, and recognizes the page content indicated by the first identifier, and the page content is the content of the target page. The display apparatus 200 obtains the DOM link of the content of the target page based on the DOM information of the content of the target page.

S1002, obtaining the content to be shared based on the unified resource locator link of the content of the target page.

For example, if the DOM link of the content of the target page is associated with the content of the target page itself, for example, if the DOM type of the content of the target page is image, then the content to be shared is the source webpage where the content of the target page is located. The position of the content of the target page in the source page can be the same as the position of the content of the target page in the current page, or it can be located in a specified location, such as the upper-left corner of the source page and the center of the source page.

For another example, if the DOM link of the content of target page is associated with another webpage, for example, the DOM type of the content of the target page is a form label, such as a button, the content to be shared is the other webpage.

S703, presenting the shared page.

The shared page includes a QR code that is associated with a DOM link included in the content of the target page and used for getting the content to be shared.

The QR code can be generated by a cloud server. The display apparatus 200 sends the DOM link of the content of the target page to the cloud server, and the cloud server generates the QR code associated with the DOM link. After receiving the QR code returned from the cloud server, the display apparatus 200 presents the QR code in the shared page. As a result, the process of generating the QR code can be centralized on the cloud server to reduce the processing pressure of the display apparatus 200.

The shared page also includes the sharing paths, which is associated with the user to be shared. The sharing paths can comprise a social application, such as phone, email, XX social application, etc.

S704, in response to a user's command based on the target sharing path, sending the QR code to the user to be shared associated with the target sharing path.

The target sharing path is the sharing path used by the current user to share the content to be shared, and the sending object of the QR code can be referred to as the target user, and the target user is the user to be shared associated with the target sharing path.

The display apparatus 200 can share the QR code according to the process shown in FIG. 47, and the specific steps are discussed below.

S1101, presenting the users associated with the target sharing path in response to a user's selection command based on the target sharing path.

The QR code on the shared page is the QR code to be shared. Each sharing path has a corresponding user list, which includes the users associated with the sharing path. The target sharing path is the sharing path selected by the user. The display apparatus 200 expands and presents the list of users associated with the target sharing path in response to a selection command, so as to make the user know users who can be shared through the target sharing path.

S1102, in response to a user's command based on an input of a target user, sending a QR code to the target user.

The display apparatus 200, in response to an input command, for example, inputting a target user, sends the QR code to the target user through the target sharing path through the network.

After the target user receives the QR code shared by the current user through the terminal device, the target user can obtain the link associated with the QR code through the terminal device, and present the content to be shared according to the link, such as the source webpage of the content of the target page or other webpages associated with the content of the target page.

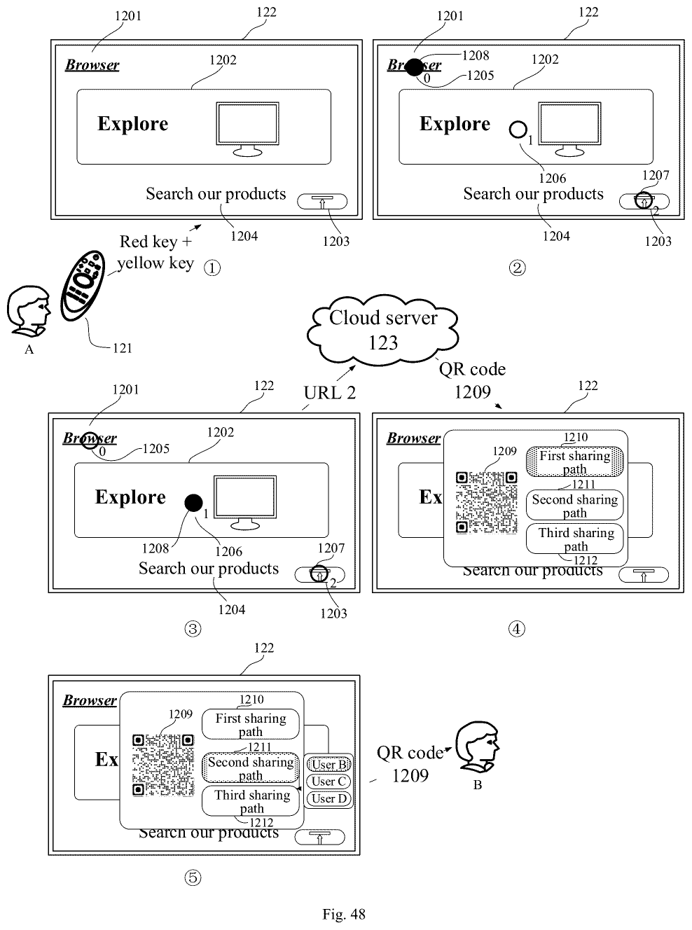

In example 1, further referring to FIG. 48, taking the current user as a user A, the control device 100 as the remote control 121, the display apparatus 200 as the TV 122, and the cloud server 123 as an example, the sharing method for the browser page in example 1 is illustrated.

TV 122 is configured with a browser application, and the page sharing mode of the browser application has been turned on. The process of turning on the page sharing mode, and the process of presenting the page sharing mode after entering the browser application, are similar to the steps S501-S502, the repeated description is omitted here. The TV 122 presents a browser page as shown in \textcircled{1} in FIG. 48, which includes a first page content 1201, a second page content 1202, a third page content 1203 and a fourth page content 1204.

Take the first combination key as the red key and the yellow key as an example, if the user presses the red key and the yellow key continuously and successively to input the first sharing command to the TV 122. The TV 122 adjusts the browser page to the first selection mode in response to the first sharing command. The TV 122 determines whether the current browser page is the page of the browser application itself in response to the first sharing command, and determines whether the link of the current browser page belongs to the blacklist after determining that the current browser page is not the page of the browser application itself, and obtains the DOM information of the page content after determining that the link of the current browser page does not belong to the blacklist. For example, the DOM information of the first page content 1201 includes: image tag, URL 1, and coordinates (x1, y1) within the current viewport. The DOM information of the second page content 1202 includes: hyperlink tags, URL 2, and coordinates (x2, y2) within the current viewport. The DOM information of the third page content 1203 includes: button label, URL 3, coordinates (x3, y3) within the current viewport. The DOM information of the fourth page content 1204 includes: text labels, no links, and coordinates (x4, y4) within the current viewport. The TV 122 can determine that the selectable page content is the first page content 1201, the second page content 1202 and the third page content 1203, and the fourth page content 1204 are the non-selectable page content. The TV 122 presents the first identifier on the first page content 1201, the second page content 1202 and the third page content 1203 as shown in (2) of FIG. 48. The coordinates of the first identifier 1205 corresponding to the first page content 1201 in the current visible area are (x1, y1), the coordinates of the second identifier 1206 corresponding to the second page content 1202 are (x2, y2) in the current visible area, and the coordinates of the first identifier 1207 corresponding to the third page content 1203 are (x3, y3) in the current visible area. In this example, each first identifier is shown as a hollow circle, and each hollow circle is highlighted. The TV 122 also sorts the first identifiers based on the coordinates of the first identifiers in the current viewing area. In this example, the coordinate system is established with the lower left corner of the current viewport as the origin, the lower edge of the current viewport as the X axis, and the left edge of the current viewport as the Y-axis. The collation can be set as follows: with X coordinates as the main and Y coordinates as supplements, when the Y coordinates are the same, the smaller the X coordinates are, corresponding identifier will be sorted first, and when the X coordinates are the same, the larger the Y coordinates are, corresponding identifier will be sorted first. Thus, the order of the first identifier 1205, the second identifier 1206, and the third identifier 1207 corresponds to 0, 1, and 2 in turn. As shown in \textcircled{2} of FIG. 48, the corresponding sort is presented in the form of a corner mark in the first identifier. The TV 122 uses focus management to add focus control and focus selection functions to each first identifier. The TV 122 is shown in \textcircled{2} of FIG. 48, the focus 1208 is first presented on the default first identifier, taking the first identifier sorted as 0 is the default first identifier as an example, and the focus 1208 is presented on the first identifier 1205 (the focus 1208 is indicated by a solid black circle in the figure). The TV 122 finishes adjusting the browser page to the first selection mode.

The user can input a move command to the TV 122 through the arrow keys on the remote control 121, and the TV 122 moves the focus 1208 on each first identifier in response to a move command, for example, as shown in \textcircled{3} of FIG. 48, the focus 1208 is moved to the second identifier 1206 for presentation, and the second identifier 1206 is the target first identifier at this moment. The user can input a selection command to the TV 122 through the confirmation key on the remote control 121. The TV 122 obtains the URL 2 of the second page content 1202 corresponding to the second identifier 1206 in response to the selection command, and determines that the content to be shared is the webpage associated with URL 2. As shown in \textcircled{3} of FIG. 48, the TV 122 sends the URL 2 to the cloud server 123. The cloud server 123 generates the associated QR code 1209 according to the URL 2, and returns the QR code 1209 to the TV 122 as shown in \textcircled{4} of FIG. 48. The TV 122 presents the shared page, and exits from the first sharing mode, after obtaining the QR code 1209. The shared page presented on TV 122 may be shown in \textcircled{4} of FIG. 48, and the shared page includes the QR code 1209 associated with the URL 2, as well as a first sharing path 1210, a second sharing path 1211 and a third sharing path 1212. The TV 122 presents the focus 1208 on the default sharing path. The sharing path that appears in the first place is the default sharing path. As shown in \textcircled{4} of FIG. 48, the TV 122 presents the focus 1208 on the first sharing path 1210 (focus 1208 is shown with a black background in the figure).

The user can input a move command to the TV 122 through the navigation keys on the remote control 121, and the TV 122, in response to a move command, moves the focus 1208 on each sharing path. As shown in \textcircled{5} of FIG. 48, the focus 1208 is moved to the second sharing path 1211 for presenting. The user can input a selection command to the TV 122 through the confirmation key on the remote control 121, and the TV 122, in response to the selection command, presents user(s) associated with the second sharing path 1211, as shown in 5 of FIG. 48, presents user(s) associated with the second sharing path 1211 in the form of a user list, including: user B, user C and user D, and presents the focus 1108 on the default user, and taking the first user in the user list as the default user as an example, presents the focus 1208 on the option of user B as shown in \textcircled{5} of FIG. 48. The user can control the TV 122 to move on the options of the users through the arrow keys on the remote control 121. Taking the target user that the user wants to share as the user B as an example, when the focus 1208 is located on the option of the user B, the user inputs a command to TV 122 through the confirmation key on the remote control 121, and the TV 122, in response to this command, sends the QR code 1209 to user B through the second sharing path 1211. In this way, the current user A shares the page content of the browser page with the user B.

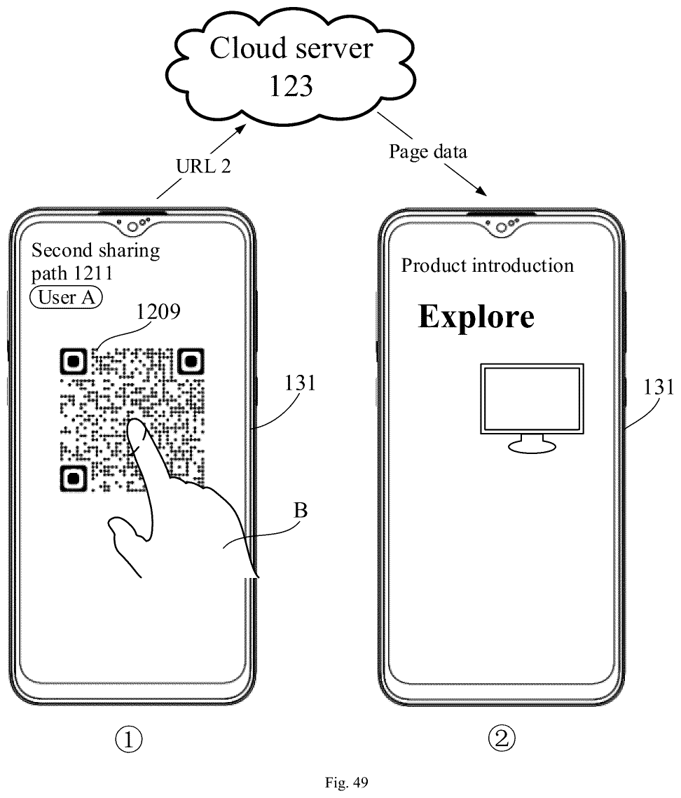

Further referring to FIG. 49, the process of presenting the shared page content after user B receives the QR code is illustrated. Taking the terminal device used by the user B as a mobile phone 131 as an example, as shown in \textcircled{1} of FIG. 49, the mobile phone 131 presents the received QR code 1209 through the second sharing path 1211. The user B can input identification command to the mobile phone 131 by long-pressing the QR code 1209 and other operations. The mobile phone 131 obtains the URL 2 associated with the QR 1209 in response to the identification command, and presents the webpage corresponding to URL 2 as shown in \textcircled{2} of FIG. 49, such as a product introduction page, and the webpage is the content to be shared corresponding to the content 1202 of the second page.

The sharing method for the browser page based on the embodiment 1 can automatically identify the content of the page to be shared by the display apparatus 200, and send a QR code associated with the content of the target page to the target user based on the user's choice. Since the corresponding content of the target page can be obtained based on the QR code, the content of the target page in the browser page can be shared by sharing the QR code.

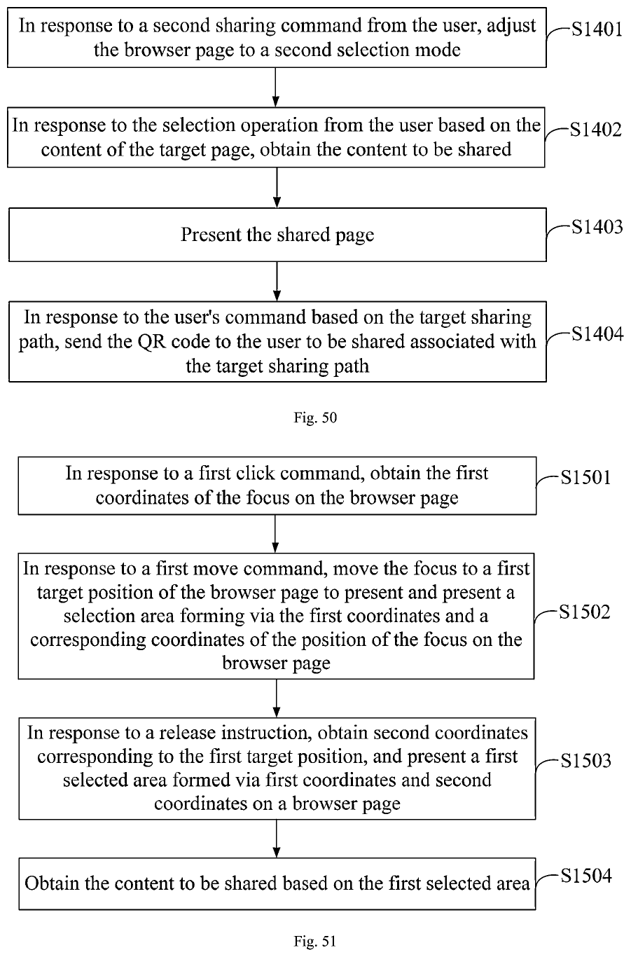

In a second example, the display apparatus 200 may share the page content of the browser page with reference to the process shown in FIG. 50, specifically including steps S1401-S1404, wherein the steps S1403-S1404 are similar to the steps S703-S704 in example 1, and are not repeated herein. The difference between the example 2 and the example 1 mainly lies in steps S1401-S1402, and steps S1401-S1402 are described below.

S1401, in response to a second sharing command from the user, adjusting the browser page to a second selection mode.

The user can input a second sharing command to the display apparatus 200 based on a second combination key on the control device 100. Take the control device 100 as the remote control as an example, and the second combination key can be a numeric key combination, blue, green, red, yellow key combination, etc. The first combination key is different from the second combination key to ensure the accuracy of the response of the display apparatus 200 to the sharing command.

The process of determining whether the browser page is a shareable page can refer to step S701 before the display apparatus 200, in response to the second sharing command, adjusts the browser page to the selection mode, which is not repeated here.

The second selection mode is a custom selection mode, that is, the user customizes the content of the target page. When the browser page is in the second selection mode, the entire page content of the browser page is selectable page content.

S1402, in response to a selection operation from the user based on the content of the target page, obtaining the content to be shared.

Based on the fact that the focus is controlled by different types of control devices 100, the process of selecting the content of the target page is also different for the display apparatus 200. In the process of selecting the content of the target page, the control device 100 can be divided into two categories from the perspective of user operation, namely, the first type of control device and the second type of control device. Here, the first type of control device is a control device that is convenient for selecting and moving the focus point at the same time, such as a mouse. The second type of control device is the control device that is not convenient for selecting and moving the focus point at the same time, such as remote control, keyboard, etc.

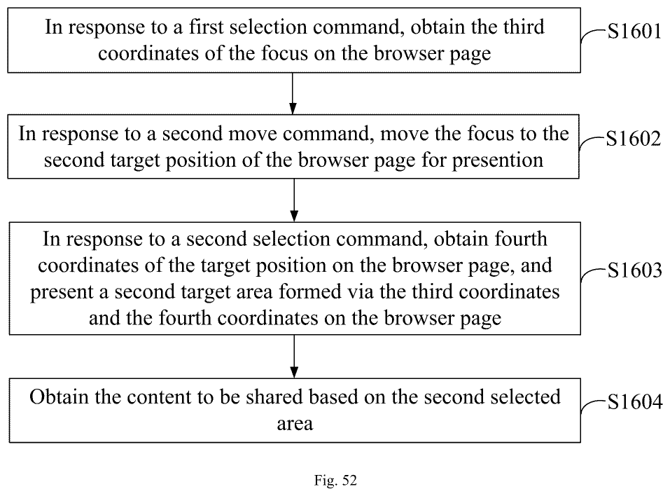

If the focus is controlled by the first type of control device, the selection operation from the user is to enter a sequential set of commands. The display apparatus 200 can obtain content to be shared according to the process shown in FIG. 51, and the specific steps are described as follows.

S1501, in response to a first click command, obtaining the first coordinates of the focus on the browser page.

The display apparatus 200, in response to the first click command, obtains the first coordinates of the focus on the browser page, and the first coordinates correspond to the starting position of the selected area.

S1502, in response to a first move command, moving the focus to a first target position of the browser page to present and presenting a selection area forming via the first coordinates and a corresponding coordinates of the position of the focus on the browser page.

The first move command indicates a moving direction and a moving distance of the focus. The display apparatus 200 presents the focus on the first target position after moving the focus at the indicated moving distance in the indicated moving direction, in response to the first move command. In the move process, the corresponding coordinates are the second coordinates, and the second coordinates correspond to the end position of the selected area. In the process of controlling the focus movement, the display apparatus 200 follows the movement of the focus and presents the selected area formed via the first coordinates and the second coordinates.

S1503, in response to a release instruction, obtaining second coordinates corresponding to the first target position, and presenting a first selected area formed via first coordinates and second coordinates on a browser page.

When the focus stops at the first target position, the display apparatus 200 obtains the second coordinates of the first target position on the browser page, and the second coordinates correspond to the end position of the selected area. In this case, the selected area formed via the first coordinates and the second coordinates is the first selected area. The first selected area is a rectangular area, and a line connecting the first coordinates and the second coordinates is the diagonal line of the first selected area. The content of the page in the first selected area is the content of the target page.

The display apparatus 200, in response to a first click command, the first move command and the release instruction, drags the focus, and customizes the content of the target page by the dragging process of the focus.

S1504, obtaining the content to be shared based on the first selected area.

The content to be shared is a screenshot of the page content in the first selected area.

The display apparatus 200 can automatically generate a corresponding screenshot according to the first selected area after determining the first selected area.

The display apparatus 200 can generate a corresponding screenshot according to the first selected area after presenting the first selected area, in response to the user's command.

In some embodiments, the selection process of the first selected area can be represented by an array. The array includes first coordinates and second coordinates. If the array is not empty, the first selected area currently exists. If the array is empty, if there are no coordinates or only the first coordinates are included, then the first selected area does not currently exist. The display apparatus 200 first determines whether the array is empty before responding to the first click command and obtains the first coordinates of the focus on the browser page, and if the array is not empty, the array is emptied to cancel the first selected area. The user needs to re-enter the selection command to select the content of the target page. If the array is recognized as empty, the first coordinates of the focus are obtained.

Thus, when the user controls the display apparatus 200 through the first type of control device, the content of the target page can be can flexibly selected by dragging the focus on the browser page.

If the focus is controlled by a second type of control device, the selection command from the user includes a first selection command, a second move command, and a second selection command. The display apparatus 200 can obtain content to be shared according to the process shown in FIG. 52, and the specific steps are described below.

S1601, in response to a first selection command, obtaining the third coordinates of the focus on the browser page.

The third coordinates correspond to the starting position of the selected area.

S1602, in response to a second move command, moving the focus to the second target position of the browser page for presentation.

The second move command indicates the moving direction and the moving distance of the focus. The display apparatus 200 presents the focus on the second target position after the moving the focus at an indicated distance in an indicated moving direction in response to the second move command.

S1603, in response to a second selection command, obtaining fourth coordinates of the target position on the browser page, and presenting a second target area formed via the third coordinates and the fourth coordinates on the browser page.

The fourth coordinates correspond to the end position of the selected area.

In order to facilitate the user to quickly determine the starting position and end position of the selected area, the display apparatus 200 presents the second identifier at the third coordinates in response to the first selection command, and presents the third identifier at the fourth coordinates in response to the second selection command. The second and third identifiers can be highlighted.

The selected area formed via the third and the fourth coordinates is the second selected area. The second selected area can be a rectangular area, and the line connecting the third coordinates and the fourth coordinates is the diagonal line of the second selected area. The content of the page in the second selected area is the content of the target page.

The users can select the content of the target page by setting the start and end positions of the second selected area separately.

In the selection operations described above, a selection operation is valid when the first selection command is the first selection command in the selection operations, and the second selection command is the second selection command in the selection operations.

An array can be used to represent the selection process of the second selected area. The array includes the length of the array, the third coordinates, and the fourth coordinates. The length of the array is represented by 0, 1, or 2, and the length of the array is used to indicate the number of selection commands.

The display apparatus 200 recognizes the length of the array in response to a selection command received.

Here, if the length of the array is 0, the selection command is the first selection command in the selection process. The display apparatus 200 obtains the third coordinates in response to the first selection command, records the third coordinates in the array, and adds 1 to the length of the array.

If the length of the array is 1, the selection command is the second selection command in the selection process. The display apparatus 200 obtains the fourth coordinates in response to the second selection command. In some embodiments, the display apparatus 200 determines whether the third coordinates are consistent with or same as the fourth coordinates, and if the third coordinates are same as the fourth coordinates, it means that the user continuously selects the same position and does not constitute a selected area, and the display apparatus 200 may display an error prompt in the form of a pop-up window to prompt the user to select another position. If the third coordinates are not same as the fourth coordinates, it means that the user has selected a different location, there is the content of the target page, and the display apparatus 200 records the fourth coordinates in the array, and adds 1 to the length of the array. The array now includes the third and fourth coordinates, and there is a second selected area.

If the length of the array is 2, the selection command is the third selection command in the selection process. In this case, the array includes both the third and fourth coordinates, indicating that there is currently a second selected area. The display apparatus 200 can present a prompt message in the form of a pop-up window to prompt the user to generate a QR code, or to re-select in response to the selection command. If the user chooses to generate a QR code, a screenshot corresponding to the second selected area will be sent to the cloud server to obtain the corresponding QR code. After the user's selection, the display apparatus 200 empties the array, that is, the length of the array is set to 0, and clears the third and fourth coordinates.

S1604, obtaining the content to be shared based on the second selected area.

The content to be shared is a screenshot of the page content in the second selected area.

Thus, when the user controls the display apparatus 200 through the second type of control device, the content of the target page can be flexibly selected by selecting the start position and the end position of the selected area.

S1403, presenting the shared page.

S1404, in response to the user's command based on the target sharing path, sending the QR code to the user to be shared associated with the target sharing path.

Steps S1403-S1404 are similar to steps S703-S704 and will not be repeated here.

When the display apparatus 200 is logged in to the user account, the display apparatus 200 sends a screenshot to the cloud server and instructs the cloud server to store the screenshot corresponding to the user account. When the user logs in to the user account again, the screenshot stored in the user account can be obtained. A number threshold can be set for the number of screen shot stored in the user account. Before storing screenshots, if it is determined that the number of stored screenshots is equal to the number threshold, the current screenshots will overwrite the oldest stored screenshots according to time of the screenshots being stored, so as to update the screenshots stored under the user account.

Combined with the following example, the method of the display apparatus 200 sharing browser page when controlled by a different types of control device in example 2 is illustrated.

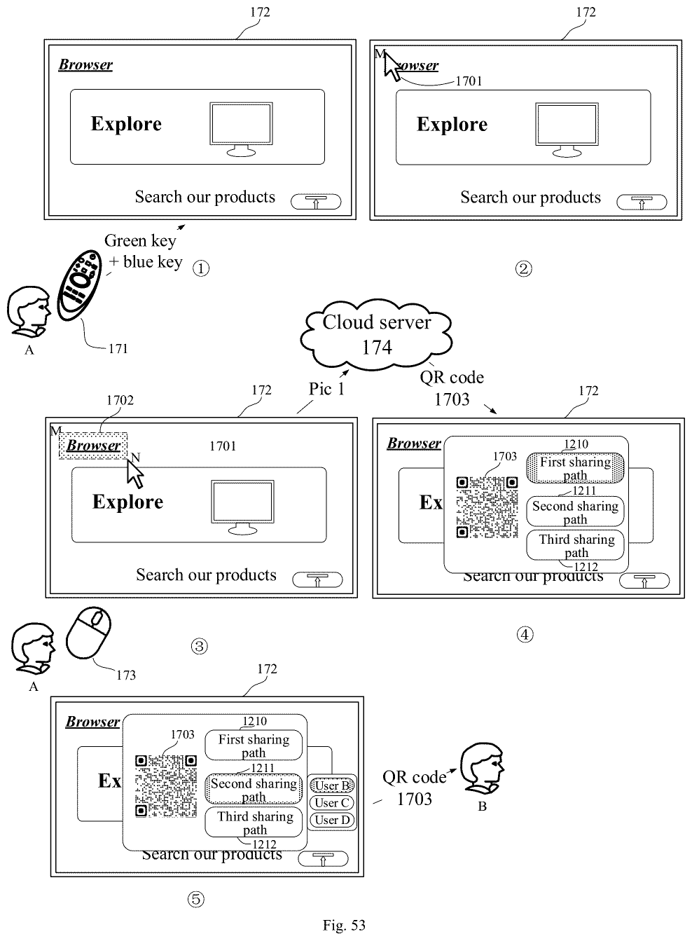

In example 2, further referring to FIG. 53, the current user is the user A, the second selection mode is turned on through the remote control 171, the content of the target page is selected through the first type of control device, the first type of control device is a mouse 173, the display apparatus 200 is a TV 172, and the corresponding cloud server 174 is taken as an example, and the sharing method for the browser page in the example 2 is illustrated.

The TV 172 is configured with a browser application, and has turned on the page sharing mode of the browser application. The process of enabling the page sharing mode, and after entering the browser application, the process of presenting the page sharing mode is similar to the steps S501-S502, and will not repeat it here.

The TV 172 presents a browser page as shown in \textcircled{1} of FIG. 53. Take the second combination key as the green key and the blue key on the remote control 171 as an example, if the user A presses the green key and the blue key continuously and successively to input the second sharing command to the TV 172. The TV 172 adjusts the browser page to the second selection mode in response to this second sharing command. In this case, all the page content of the browser page is the page content that can be selected. The TV presents the focus 1701 in the browser page as shown in \textcircled{2} of FIG. 53, and the focus 1701 is in an arrow pattern in this figure, and the focus 1701 is used to indicate the selected area. When the TV 172 presents the focus 1701, it can first present it in the default position of the browser page, such as the center position. The TV 172 finishes adjusting the browser page to the second selection mode.

As shown in \textcircled{2} of FIG. 53, when the focus 1701 is at the M position, the user A can input the first click command through the left button of the mouse 173, and when the left button is continuously pressed, the user A inputs the first move command by sliding the mouse 173, and after the focus 1701 reaches the N position shown in \textcircled{3} of the FIG. 53, releases the pressure on the left button, and issues a release instruction. Here, after receiving the first click command, the TV 172 first determines whether the array used to represent the selected area is empty. When the array is identified to be empty, the TV 172 obtains the first coordinates of the focus 1701 at the M position in response to the first click command, as (x_{M}, y_{M}), and in response to a release instruction, obtains the second coordinates of the focus 1701 at the N position, as (x_{N}, y_{N}). The TV is shown in \textcircled{3} of FIG. 53, and the TV 172 also presents a first selected area 1702 formed by the first coordinates and the second coordinates. The first selected area 1702 can be rectangular. Here, the M position is the starting position of the first selected region 1702, the N position is the end position of the first selected region 1702, and the page content in the first selected region 1702 is the content of the target page.

The user A can input confirmation command through the right click of mouse 173, and the TV 172 intercepts the browser page according to the first selected area 1702 in response to this confirmation command, and obtains corresponding screenshot, such as screenshot pic 1. As shown in \textcircled{3} of FIG. 53, the TV 172 uploads the screenshot pic 1 to a cloud server 174, and the cloud server 174 stores the screenshot pic 1, generates a QR code 1703 according to the storage address of the screenshot pic 1, and returns the QR code 1703 to the TV 172 as shown in \textcircled{4} of FIG. 53. The TV 172 presents a shared page as shown in 5 of FIG. 53. The shared page shown in \textcircled{5} of FIG. 53 is similar to the shared page shown in \textcircled{4} of FIG. 48, the difference is that the shared page shown in \textcircled{5} of FIG. 53 includes a QR code 1703, the QR code 1703 is used for obtaining a screenshot pic 1, and the focus 1701 is presented on the first sharing path 1210 by default (the focus 1701 is shown in a black background at this moment). The TV 172 turns off the second sharing mode and resumes the non-sharing mode.

As shown in \textcircled{5} of FIG. 53, the user A shares the QR code 1703 with the target user based on the shared page, and the process can refer to the description in Example 1 corresponding to \textcircled{5} in FIG. 48, and will not repeated here.

The process of obtaining a screenshot pic 1 based on the received QR code 1703 can refer to the description corresponding to FIG. 49 in Example 1, and the difference is that after the target user uses a terminal device to identify the QR code 1703, to obtain the storage address of the screenshot pic 1 in the cloud server 174, thereby obtaining the screenshot pic 1 according to the storage address, and presenting the screenshot pic 1.

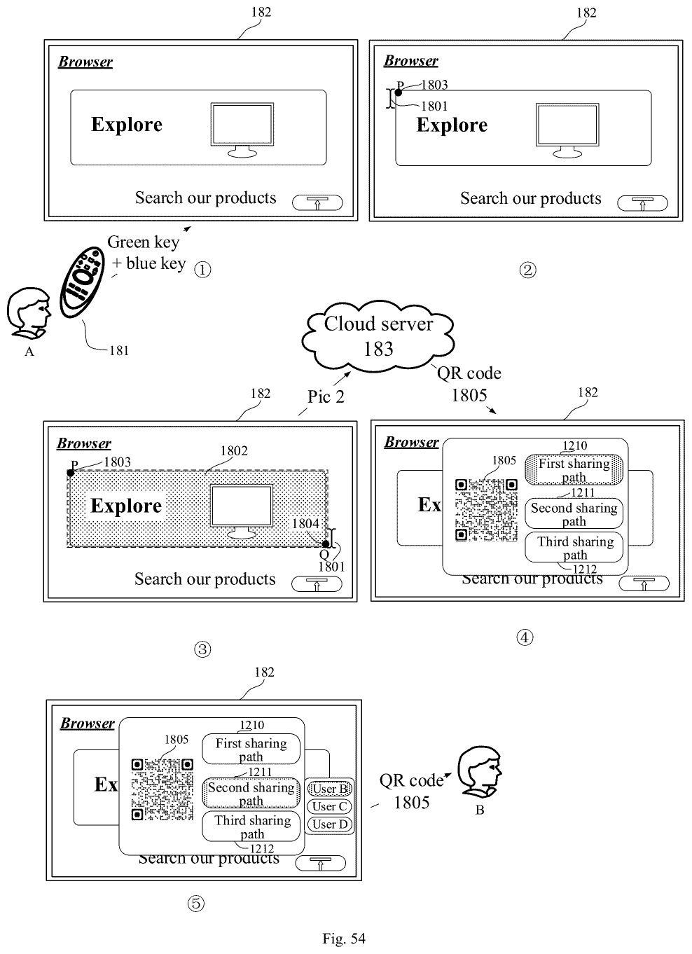

In example 3, further referring to FIG. 54, the current user is the user A, the second selection mode is turned on through the remote control 181, the content of the target page is selected through the second type of control device, the second type of control device is the remote control 181, the display apparatus 200 is the TV 182, and the corresponding cloud server 183 is taken as an example, and the sharing method for the browser page in the example 2 is illustrated.

The TV 182 is configured with a browser application, and the page sharing mode of the browser application is turned on. The process of turning on the page sharing mode, and the process of presenting the page sharing mode after entering the browser application, are similar to the steps S501-S502, and will not be repeated here.

The TV 182 presents a browser page as shown in \textcircled{1} of FIG. 54. Take the second combination key as the green key and the blue key on the remote control 181 as an example, if the user A continuously presses the green key and the blue key continuously and successively to input the second sharing command to the TV 182. The TV 182 adjusts the browser page to the second selection mode in response to this second sharing command. In this case, all page content of the browser page is selectable or available for selection of page content. The TV presents the focus 1801 in the browser page as shown in \textcircled{2} of FIG. 54, and the focus 1801 is cursor-style, and the focus 1801 is used for setting the start position and the end position of the selected area. When the TV 182 presents the focus 1801, the focus 1801 can first be presented in the default position of the browser page, such as the upper left corner. The TV 182 finishes adjusting the browser page to the second selection mode.

The user A can input a selection command to the TV 182 through the remote control 181. Here, the user A can input the first selection command through the confirmation key of the remote control 181, and the TV 182 obtains the third coordinates of the focus 1801 in response to the first selection command. Taking the current P position of the focus 1801 as an example, and the TV 182 obtains the coordinates of the P position, such as (x_{P}, y_{P}). The user A can input the second move command through the arrow keys of the remote control 181, and the TV 182 moves the focus 1801 from the P position to the Q position as shown in \textcircled{3} of FIG. 54 in response to this second move command. The user A can input the second selection command through the confirmation key of the remote control 181, and the TV 182 obtains the fourth coordinates of the focus 1801 in response to the second selection command, that is, obtains the coordinates of the Q position, such as (x_{Q}, y_{Q}). As shown in \textcircled{3} of FIG. 54, the TV 182 also presents a second selected area 1802 formed via the third coordinates and the fourth coordinates, and the second selected area 1802 can be rectangular. In order to show the user more clearly the starting position and end position of the second selected area 1802, the second identifier 1803 can be presented at the third coordinates and the third identifier 1804 can be presented at the fourth coordinates as shown in \textcircled{2} and \textcircled{3} of FIG. 54. In this example, the second identifier 1803 and the third identifier 1804 are styled as a filled circle.

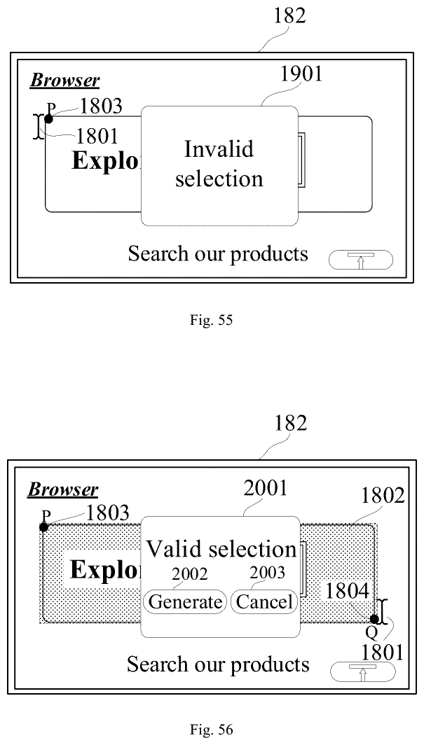

In the above-mentioned selecting process, the TV 182 needs to determine whether the first selection command and the second selection command are respectively the first selection command and the second selection command in the selection process. Here, after receiving the first selection command, the TV 182 first determines whether the length of the array used to represent the selected area is 0, and when the length of the array is 0, determines that the first selection command is the first selection command in the selecting process, and responds to the first selection command to obtain the third coordinates. After receiving the second selection command, the TV 182 first determines whether the length of the array used to represent the selected area is 1, and when the length of the array is 1, in response to the second selection command, obtains the fourth coordinates. The TV 182 further determines whether the third coordinates and the fourth coordinates are consistent with or same as each other, and records the fourth coordinates when the third coordinates are inconsistent with or not same as the fourth coordinates. If the third coordinates and the fourth coordinates are consistent with or same as each other, a pop-up window 1901 as shown in FIG. 55 can be presented. The pop-up window 1901 includes an error message, such as “invalid selection”, to prompt the user that the current selection command is invalid. If the TV 182 recognizes that the length of the array is 2 after receiving the first selection command, then determines that the first selection command is the third selection command, and there is a second selected area at present. Taking the existence of the second selected area 1802 as an example, the TV 182 can present a pop-up window 2001 as shown in FIG. 56, and the pop-up window 2001 includes an option 2002 for generating a QR code and an option 2003 for canceling. If user A chooses the option 2002 to generate a QR code 2002, then the TV 182 will generate a screenshot according to the current second selected area and obtain the corresponding QR code. If user A chooses to the option 2003 for cancelling, then the TV 182 cancels the current second selected area, and clears the corresponding array. In this case, the user A can select the second selected area again.

If user A selects the option 200 to generate a QR code, the TV 182 takes a screenshot of the browser page according to the second selected area 1802, and obtains a corresponding screenshot, such as the screenshot pic 2. As shown in \textcircled{3} of FIG. 54, the TV 182 uploads screenshot pic 2 to a cloud server 183. The cloud server 183 stores screenshot pic 2, and generates a QR code 1805 according to the storage address of screenshot pic 2, and returns the QR code 1805 to the TV 182 as shown in \textcircled{4} of FIG. 24. The TV 182 presents a shared page as shown in \textcircled{4} of FIG. 54. The shared page shown in \textcircled{4} of FIG. 54 is similar to the shared page shown in \textcircled{4} of FIG. 53, the difference is that the shared page shown in \textcircled{4} of FIG. 54 includes a QR code 1805, the QR code 1805 is used for obtaining a screenshot pic 2, and the focus 1801 is presented on the first sharing path 1210 by default (the focus 1801 is shown in black background in this figure). The TV 182 turns off the second sharing mode and resumes the non-sharing mode.

As shown in \textcircled{5} of FIG. 54, the user A shares the QR code 1805 with the target user based on the shared page, and the process can refer to the description in Example 1 corresponding to \textcircled{5} in FIG. 48, and will not be repeated here.

The process of obtaining the screenshot pic 2 based on the received QR code 1805 can refer to the description corresponding to FIG. 49 in Example 1, and the difference is that after the target user uses a terminal device to identify the QR code 1805, the storage address of the screenshot pic 2 in the cloud server 183 can be obtained, thereby obtaining the screenshot pic 2 according to the storage address, and presenting the screenshot pic 2.

According to the sharing method for the browser page based on the example 2, the content to be shared of the target page can be custom-selected by the user, and the display apparatus 200 sends a QR associated with the content of the target page to the target user based on the selection operation from the user. Since the corresponding content of the target page can be obtained based on the QR code, the content of the target page in the browser page can be shared by sharing the QR code.

For the sake of ease of explanation, the above descriptions have been made in combination with the specific embodiments. However, the above illustrative discussion is not intended to be exhaustive or to limit the means of implementation to the specific forms of disclosure described above. According to the above teachings, a variety of modifications and variations can be obtained. The selection and description of the above embodiments are for the purpose of better explaining the principle and practical application, so that those skilled in the art can better use the embodiments and various different variant embodiments suitable for specific use considerations.

What is claimed is:

1. A display apparatus, comprising:
a display, configured to present an image and/or a user interface; and
at least one processor, configured to execute computer instructions to cause the display apparatus to:
display a page from a browser application in the display apparatus on the display, and in response to a favorite operation for a target webpage in the browser application, determine a webpage loading mode in the display apparatus;
obtain icon information of the target webpage based on the webpage loading mode in the display apparatus; and
based on a selection operation for the icon information of the target webpage, present the target webpage on the display;
wherein the webpage loading mode in the display apparatus comprises a first loading mode and a second loading mode, and a webpage loading speed when the display apparatus is in the first loading mode is less than a webpage loading speed when the display apparatus is in the second loading mode;
wherein the at least one processor is further configured to execute the computer instructions to cause the display apparatus to:
based on that the webpage loading mode is the first loading mode and a domain name of the target webpage is a first-level domain name, search a preset icon corresponding to the target webpage in a preset icon library to obtain the icon information of the target webpage; and
based on that the domain name of the target webpage is not the first-level domain name, obtain homepage screenshot information of the target webpage and generate the icon information of the target webpage based on the homepage screenshot information.

2. The display apparatus according to claim 1, wherein the at least one processor is further configured to execute the computer instructions to cause the display apparatus to:
based on that no preset icon corresponding to the target webpage is found in the preset icon library, obtain the icon information of the target webpage through a target browser.

3. The display apparatus according to claim 1, wherein the target webpage comprises a preset webpage pre-configured in the display apparatus, and the at least one processor is further configured to execute the computer instructions to cause the display apparatus to:
based on that the webpage loading mode in the display apparatus is the second loading mode, control the browser application to present icon information of the preset webpage; and
based on a selection operation of icon information for the preset webpage, present the preset webpage on the display.

4. The display apparatus according to claim 3, wherein the at least one processor is further configured to execute the computer instructions to cause the display apparatus to:
search a preset icon corresponding to the preset webpage in a preset icon library to obtain the icon information of the preset webpage.

5. The display apparatus according to claim 3, wherein the at least one processor is further configured to execute the computer instructions to cause the display apparatus to:
based on that no preset icon corresponding to the preset webpage is found in the preset icon library, obtain the icon information of the preset webpage through a target browser.

6. A control method for a display apparatus, comprising:
displaying a page from a browser application in the display apparatus on a user interface presented on a display of a display apparatus, in response to a favorite operation for the target webpage in the browser application, determining a webpage loading mode in the display apparatus;
obtaining icon information of the target webpage based on the webpage loading mode in the display apparatus;
based on a selection operation for the icon information of the target webpage, presenting the target webpage on the display;
wherein the webpage loading mode in the display apparatus comprises a first loading mode and a second loading mode, and a webpage loading speed when the display apparatus is in the first loading mode is less than a webpage loading speed when the display apparatus is in the second loading mode;
based on that the webpage loading mode is the first loading mode and a domain name of the target webpage is a first-level domain name, searching a preset icon corresponding to the target webpage in a preset icon library to obtain the icon information of the target webpage; and
based on that the domain name of the target webpage is not the first-level domain name, obtaining homepage screenshot information of the target webpage and generating the icon information of the target webpage based on the homepage screenshot information.

7. The method according to claim 6, further comprising:
based on that no preset icon corresponding to the target webpage is found in the preset icon library, obtaining the icon information of the target webpage through a target browser.

8. The method according to claim 6, further comprising:
based on that the webpage loading mode in the display apparatus is the second loading mode, control the browser application to present icon information of the preset webpage; and
based on a selection operation of icon information for the preset webpage, present the preset webpage on the display.

9. The method according to claim 8, further comprising:
searching a preset icon corresponding to the preset webpage in a preset icon library to obtain the icon information of the preset webpage.

10. The method according to claim 8, further comprising:
based on that no preset icon corresponding to the preset webpage is found in the preset icon library, obtaining the icon information of the preset webpage through a target browser.
